(19) United States
(12) Patent Application Publication
(10) Pub. No.: US 2026/0128816 A1
(43) Pub. Date: May 7, 2026

(54) METHODS, APPARATUS, AND SYSTEMS FOR MIXED TRAFFIC CODING

(71) Applicant: Huawei Technologies Co., Ltd., Shenzhen (CN)

(72) Inventors: Yu Cao, Ottawa (CA); Huazi Zhang, Hangzhou (CN); Van Hung Vu, Gatineau (CA); Jianglei Ma, Ottawa (CA)

(21) Appl. No.: 19/435,203

(22) Filed: Dec. 29, 2025

Related U.S. Application Data
(63) Continuation of application No. PCT/CN2023/133331, filed on Nov. 22, 2023.
(60) Provisional application No. 63/511,216, filed on Jun. 30, 2023.

(51) Int. Cl. H04L 1/00; H04L 47/2425

(52) U.S. Cl. CPC H04L 1/0058; H04L 47/2433

(57) ABSTRACT

A first codeword is generated by encoding a first code block of a first code block group that is associated with a first traffic type, and a second codeword is generated by encoding a second code block of a second code block group that is associated with a second traffic type different from the first traffic type. The first code block includes information bits from only the first traffic type, and the second code block includes information bits from the second traffic type and bits associated with the first code block. The first codeword is decodable independently of the second codeword, and is further decodable jointly with the second codeword.

### CROSS-REFERENCE TO RELATED APPLICATION

The present application is a continuation of International Patent Application No. PCT/CN2023/133331, filed on Nov. 22, 2023, which claims the benefit of U.S. provisional patent application Ser. No. 63/511,216, entitled “Method, Apparatus, and System for Mixed Traffic Code Block Mapping”, filed on Jun. 30, 2023. The entire contents of these applications are hereby incorporated by reference.

### TECHNICAL FIELD

The present application relates to coding for wireless communications, and in particular to mixed traffic coding based on traffic type.

### BACKGROUND

Resilience is a fundamental feature that needs to be addressed in 6G. With the evolution of Industry 4.0 and many other technology visions, ultra-reliable and low latency wireless communications are a pivotal enabler for automated manufacturing on a massive scale.

6G refers to sixth generation. Industry 4.0 refers generally to factories and industries.

Two trends are observed toward 6G. From a technological perspective, mmWave and massive MIMO will be more prevalent because they can significantly expand current bandwidth resources. From the service perspective, a single communication device will likely need to support multiple services with different latency and reliability requirements. These two trends, together with the more stringent resilience requirement, provide an opportunity to re-design the physical layer.

The abbreviation mmWave refers to millimeter-wavelength. MIMO refers to multiple input multiple output.

A potential scenario emerges as multiple services converge into one physical wireless link. The purpose is to deliver multiple QoS to multiple services within only one wireless link. Given the high carrier frequency and massive antennas, beamforming can be done more aggressively, enabling the convergence of multiple services in one wireless link. Meanwhile, these services may have very diverse KPIs. For example, URLLC, mMTC, eMBB and Tbps communications may all be integrated in one beam. This is challenging because different KPIs must be supported under the same wireless channel (SNR, fading, etc.).

The acronyms referenced above are as follows: QoS (quality of service); KPIs (key performance indicators); URLLC (ultra-reliable low latency communications); mMTC (massive machine type communications), eMBB (enhanced mobile broadband); Tbps (terabit per second); SNR (signal to noise ratio).

When a UE is being scheduled a transmission, the UE selects a logical channel based on its priority and other information, and maps the logical channel to a transport channel to be used for encoding. The encoding operation and physical layer transmission scheme are independent of the traffic type. Therefore, different traffic types are usually separately encoded and the encoding procedure is done regardless of the traffic type.

UE refers to user equipment.

When a UE has multiple traffic types (URLLC for example), it is generally not efficient to encode them separately. The reliability of URLLC code length may be limited due to short code length, which usually has lower coding gain.

Separate encoding and transmission of more important data with a lower rate is not efficient, as it cannot benefit from the coding gain of a longer code when the more important data is relatively short. To achieve the same reliability, more code bits are usually required. As such, spectral efficiency will be reduced and, moreover, extra signaling overhead will be required, for resource allocation for example.

Thus, there presents an additional problem of how to encode and transmit different traffic types efficiently when multiple traffic types are available for the same UE.

### SUMMARY

Some examples below relate to methods of performing CB segmentations and CBG portioning with mixed traffic scenarios as well as methods of resource mapping and payload sharing in relation to different CBs of mixed traffic coding.

CB refers to code block. CBG refers to code block group. Portioning may also be called partitioning.

Methods are referenced above and elsewhere herein, but other embodiments are also disclosed.

According to an aspect of the present disclosure, a method involves encoding a code blocks to generate codewords including a first codeword and a second codeword, and outputting the first codeword and the second codeword.

Another method disclosed herein involves receiving codewords, including a first codeword and a second codeword, generated by encoding code blocks, and decoding the first codeword and the second codeword.

An apparatus according to an embodiment includes an encoder for encoding code blocks to generate codewords including a first codeword and a second codeword, and an interface, coupled to the encoder, for outputting the first codeword and the second codeword.

Another apparatus disclosed herein includes an interface for receiving codewords, including a first codeword and a second codeword, generated by encoding code blocks, and a decoder, coupled to the interface, for decoding the first codeword and the second codeword to obtain the first code block and the second code block.

A system is also disclosed, and may include: a first communication device configured to encode code blocks to generate codewords including a first codeword and a second codeword, and to transmit the codewords; and a second communication device configured to receive and decode the first codeword and the second codeword.

In these examples, and others herein, the first codeword is generated by encoding a first code block of a first code block group that is associated with a first traffic type, and a second codeword generated by encoding a second code block of a second code block group that is associated with a second traffic type different from the first traffic type. The first code block includes information bits from only the first traffic type, and the second code block includes information bits from the second traffic type and bits associated with the first code block. The first codeword is decodable independently of the second codeword, and is further decodable jointly with the second codeword.

In other apparatus embodiments, an apparatus may include a processor configured to cause the apparatus to perform any of the methods as disclosed herein.

An apparatus may include a processor and a non-transitory computer readable storage medium that is coupled to the processor and stores programming for execution by the processor.

A storage medium need not necessarily or only be implemented in or in conjunction with such an apparatus. A computer program product, for example, may be or include a non-transitory computer readable medium storing programming for execution by a processor.

Programming stored by a computer readable storage medium may include instructions to, or to cause a processor to, perform, implement, support, or enable any of the methods disclosed herein.

The present disclosure encompasses these and other aspects or embodiments.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system.

FIG. 2 is a block diagram illustration of the example communication system in FIG. 1.

FIG. 3 illustrates an example electronic device and examples of base stations.

FIG. 4 illustrates units or modules in a device.

FIG. 5 is a block diagram illustrating an example multi-service scenario.

FIG. 6 is a block diagram illustrating self-decoding and joint-decoding.

FIG. 7 is a block diagram illustrating a robot arm that includes a video device and two joints, and communicates with a base station.

FIG. 8 is a block diagram illustrating an example code block and encoded symbols.

FIG. 9 is a block diagram illustrating another example code block and encoded symbols.

FIG. 10 is a block diagram illustrating yet another example code block and encoded symbols.

FIG. 11 is a block diagram illustrating sequential coupling of bits between individual payloads.

FIG. 12 is a block diagram illustrating multi-to-one coupling of bits between individual payloads.

FIG. 13A illustrates a mixed traffic scheduling example.

FIG. 13B illustrates another mixed traffic scheduling example.

FIG. 14 is a signal flow diagram illustrating mixed traffic scheduling.

FIG. 15A illustrates a further mixed traffic scheduling example.

FIG. 15B illustrates yet another mixed traffic scheduling example.

FIG. 16 is a signal flow diagram illustrating mixed traffic scheduling, with separate scheduling of different traffic types.

FIG. 17 illustrates an example CB segmentation procedure for mixed traffic coding in the same transport block (TB).

FIG. 18 illustrates an example URLLC traffic encoding procedure.

FIG. 19 illustrates an example eMBB traffic encoding procedure.

FIG. 20 is a block diagram of an example encoding chain according to an embodiment.

FIG. 21 illustrates examples of different resource mapping approaches for mixed traffic coding.

FIG. 22 illustrates an example of eMBB-URLLC pre-emption.

FIG. 23 is a flow diagram illustrating example methods according to embodiments.

FIG. 24 includes block diagrams illustrating apparatus according to embodiments.

### DETAILED DESCRIPTION OF THE ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

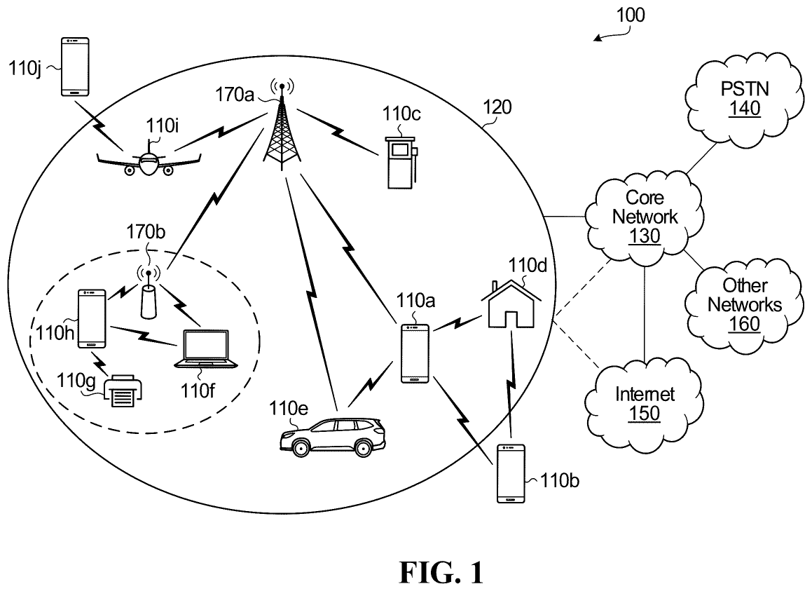

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

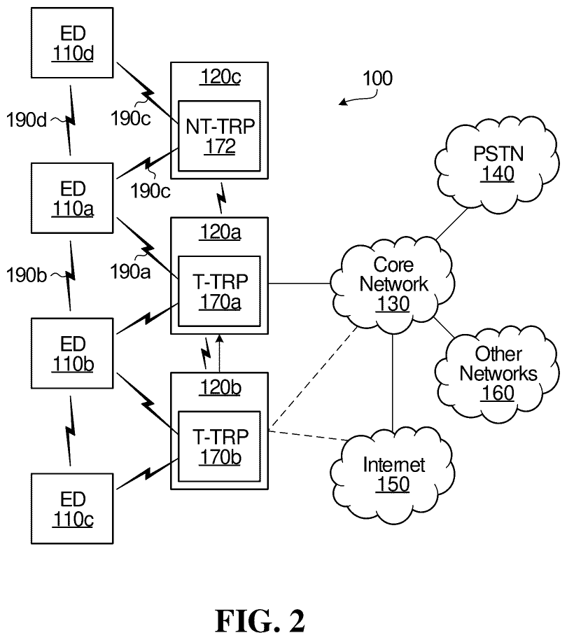

FIG. 2 illustrates an example communication system 100. In general, the communication system 100 enables multiple wireless or wired elements to communicate data and other content. The purpose of the communication system 100 may be to provide content, such as voice, data, video, signaling, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANS 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the Eds 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), Discrete Fourier Transform spread OFDMA (DFT-OFDMA) or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of Eds 110 and one or multiple NT-TRPs 172 for multicast transmission.

The RANs 120a and 120b are in communication with the core network 130 to provide the Eds 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the Eds 110a, 110b, 110c or both, and (ii) other networks (such as the PSTN 140, the Internet 150, and the other networks 160). In addition, some or all of the Eds 110a, 110b, 110c may include functionality for communicating with different wireless networks over different wireless links using different wireless technologies and/or protocols. Instead of wireless communication (or in addition thereto), the Eds 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The Eds 110a, 110b, 110c may be multimode devices capable of operation according to multiple radio access technologies and may incorporate multiple transceivers necessary to support such.

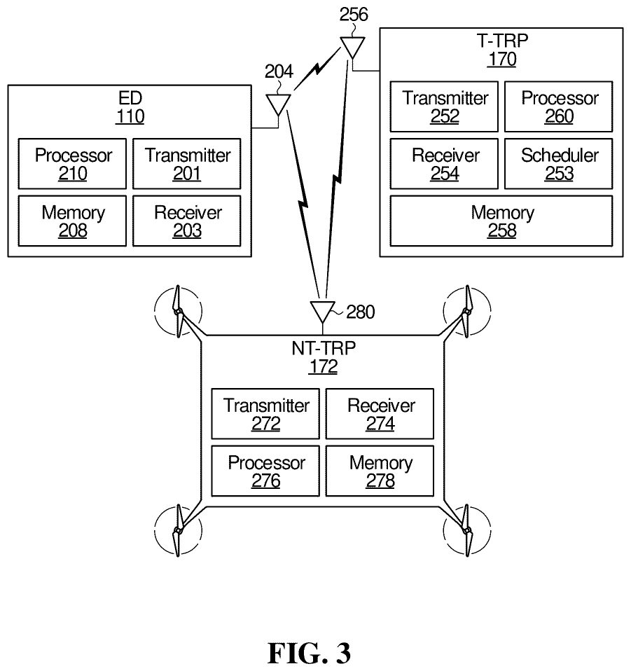

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices such as a watch, head mounted equipment, a pair of glasses, an industrial device, or apparatus (e.g., communication module, modem, or chip) in the forgoing devices, among other possibilities. Future generation Eds 110 may be referred to using other terms. Each base station 170a and 170b is a T-TRP and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., in the memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), a Central Processing Unit (CPU) or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU, a CPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

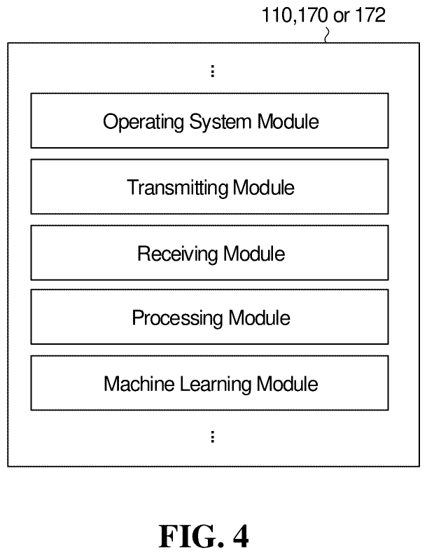

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or by a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, a CPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the Eds 110, the T-TRP 170 and the NT-TRP 172 are known to those of skill in the art. As such, these details are omitted here.

Having considered communications more generally above, attention will now turn to particular example embodiments.

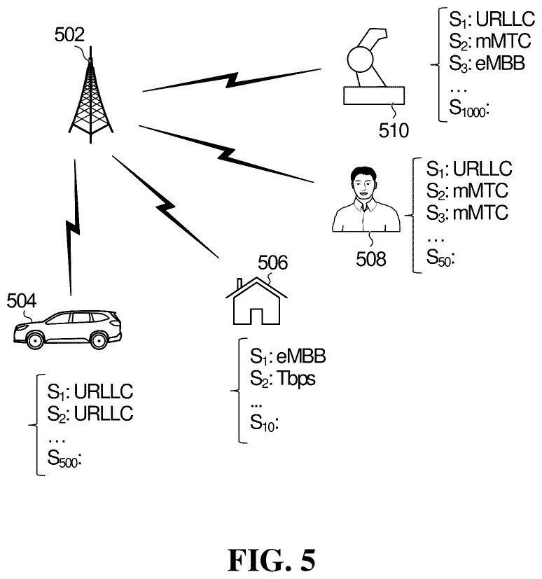

As referenced above, multiple services may converge or be integrated, into one beam or physical wireless link for example, and these services may have diverse KPIs. FIG. 5 is a block diagram illustrating an example multi-service scenario, in which services integrated into one link may include any of URLLC, mMTC, eMBB, and Tbps services. In FIG. 5, communication devices include a network device 502, a vehicle-based device represented at 504, a home-based or other premises-based device represented at 506, a user device represented at 508, and an industrial or machine-based device represented at 510, each with example services as shown.

The present disclosure is not limited to these or any other types of devices or services. FIG. 5 is intended to provide one example scenario in which embodiments disclosed herein may be particularly useful. More generally, disclosed embodiments may be implemented, for example, in next-generation mobile and wireless network services, cloud and edge computing services, and sensing services. Some embodiments may be particularly useful for automated manufacturing systems in smart factories, and/or other intelligent vertical scenarios such as ports, delivery systems, and medical systems. These possible applications of embodiments are also illustrative and non-limiting examples.

A multi-service scenario, such as the scenario shown by way of example in FIG. 5, may be considered a form of intra-UE multiple access (MA). Intra-UE MA refers to concurrent transmissions of multiple services from one terminal device.

In channel coding, the coding gain depends heavily on code length and rates. Longer codes and lower code rates typically lead to better error correction performance. In some channel coding designs, code lengths and rates are adjusted to the current channel states in an adaptive way, based on CQI feedback and scheduling algorithms.

CQI refers to channel quality indicator.

In some current mobile communication systems, data from different applications or sources will be grouped into separate bulks of payloads, and will be encoded, transmitted and decoded separately.

### Intra-UE Priority Handling

A UE may experience conflict in resources used to transmit data such as PUSCH, and/or control information such as PUCCH. In this case a priority handling rule should define which resource should be dropped (not transmitted) in case of conflict.

In a multi-service scenario, this may be referred to as intra-UE priority handling.

PUSCH refers to physical uplink shared channel. PUCCH refers to physical uplink control channel.

### CBG Based Retransmission

In a CBG-based HARQ retransmission scheme, each TB may contain multiple CBs, and the CBs can be grouped evenly into multiple CBGs. Each CBG contains the same number of CBs. HARQ feedback sent by a UE to a BS can contain ACK or NACK for each CBG rather than a single ACK or NACK for the whole TB. In this case, if some CBGs are decoded successfully and some CBGs are not decoded successfully after an initial transmission, the BS can choose to retransmit only the CBGs that are not decoded successfully, which saves retransmission resources in comparison to TB based retransmission.

This may be referred to as CBG based retransmission.

In the above example, HARQ refers to hybrid automatic repeat request, TB refers to transport block, ACK refers to acknowledgement, and NACK refers to negative acknowledgement.

Some examples below relate to methods of performing CB segmentations and CBG portioning with mixed traffic scenarios as well as methods of resource mapping and payload sharing in relation to different CBs of mixed traffic coding.

Some points in the examples below are summarized as follows:
Traffic aware CB segmentation and resource mapping for mixed traffic coding
Traffic aware CB segmentation
Traffic dependent maximum CB size
Traffic aware CBG partitioning
Traffic dependent resource mapping order
Priority ordered CB indicing
Shared payload distributions for better protection
Evenly distributed among CBs in a TB/CBG
Repeating in multiple CBs
Mixed traffic coding solution for eMBB-URLLC multiplexing
URLLC multiplexed in an eMBB CBG only.

These are examples of features, any one or more of which may be provided or supported in embodiments disclosed herein. Regarding some of these examples: indicing may also be referred to as indexing; eMBB-URLLC multiplexing may also be referred to as pre-emption or conflict handling, for example.

In mixed traffic coding, the scenario considers multiple services (at least two services) with different traffic types. The first traffic type (e.g. URLLC) may be protected by a small code (small code length) while the second traffic type (e.g. eMBB) may be protected by a larger code because of large payload. A main idea of mixed traffic coding is to embed part or all of the information bits from the small code into the payload of the larger code and encode (using an error-correction code for example) them together in the larger code. Decoding the small code can enhance the decoding of the larger code, while decoding of larger code can also improve the reliability of the small code if the small code cannot be independently decoded, which reduces the likelihood of requiring retransmission of the small code.

In this example, and others herein, reference is made to multiple services. However, features disclosed in respect of multiple services may apply more generally multiple traffic types, which may or may not necessarily be associated with different services. A small or smaller code or code length may also be referred to as a short or shorter code or code length. Similarly, a large or larger code or code length may be referred to as a long or longer code or code length. In mixed traffic coding with part or all of the information bits from a first code embedded into the payload of a second code, bits of the combined payload (including the embedded information bits) are encoded together in the second code.

Some embodiments of the present disclosure add a new procedure between a decoding failure and a request for a retransmission. This is achieved by integrating various services into a single FEC, with awareness of service priority (target BLER, latency and sources). Meanwhile, a corresponding channel coding method supports both self decodability and enhanced joint decodability.

Integrating various services into a single forward error correction (FEC) code is one example of integration. Services, or more generally traffic types, may be integrated into a single FEC code, or into a single block or payload for encoding. Service priorities may refer to any of various properties or characteristics, such as any one or more of the examples above, which include target block error rate (BLER), latency, and sources. Self decodability and enhanced joint decodability are examples of other features that may be provided or supported in embodiments.

Some embodiments of the present disclosure include a three-decoding-attempt transmission paradigm, where a new procedure called joint decoding is inserted between a decoding failure and a retransmission request.

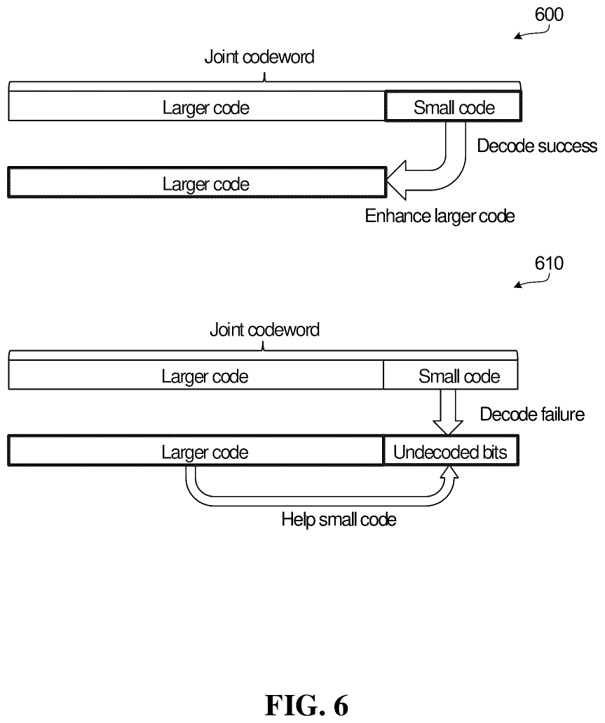

A three-decoding-attempt transmission paradigm is one example of an approach in which multiple decoding attempts may be made before requesting retransmission. Joint decoding is an example of a new procedure that may in effect be inserted or attempted between a decoding failure and a retransmission request. FIG. 6 is a block diagram illustrating self-decoding and joint-decoding, and is referenced below in the context of this example.

In a first decoding attempt, a receiver decodes a first payload after receiving a corresponding minimum required code bits (LLRs). If the decoding of the first payload is successful, it uses the correctly decoded bits to enhance the decoding performance of a second payload after the corresponding minimum required code bits are received.

The first payload is self-decodable, and the minimum required code bits refers to the minimum number of code bits from which the first payload can possibly be decoded. LLRs refers to log-likelihood ratios as one illustrative example of code bits. Successful decoding of the first payload is shown at 600 in FIG. 6, and FIG. 6 also illustrates that the correctly decoded bits can be used to enhance decoding performance for a second payload. The corresponding minimum required code bits for the second payload refers to the minimum number of code bits from which the second payload can possibly be decoded.

In a second decoding attempt, if the decoding of the first payload fails, the receiver will not request a retransmission, but proceed to jointly decode the first payload with the second payload. After the decoding of the second payload (no matter success or failure), the joint decoding feature can help ensure that the first payload will be successfully decoded with a high probability.

A second decoding attempt is shown at 610 in FIG. 6.

In a third attempt, if the decoding of the first payload still fails after the second decoding attempt, the receiver will request a retransmission from the transmitter. This will incur some delay, but the receiver will decode a third time with both the joint code word and the retransmitted codeword.

More generally with a retransmitted codeword, multiple decoding attempts may be made, to self-decode from the retransmitted codeword, jointly decode from parts of the retransmitted codeword, and/or jointly decode using both the previously received codeword and the retransmitted codeword.

Some embodiments of the present disclosure include a self-decodable joint coding design, such that each individual payload (corresponding to a service for example) can be self-decoded, and at the same time support joint decoding to further enhance performance.

An illustrative example a self-decodable joint coding design is outlined below. Embed several small messages into a longer code block; Small messages are self-decodable, meaning they can be decoded after collecting a subset of the code bits (or symbols, LLRs); the subset of code bits is also a standalone short code;

Two or more small messages are jointly-decodable; the corresponding subsets of the code bits combine into a longer code. This is done through “coupling” between bits from the two messages. Specifically, all or a subset of the first message (here message means information bits—that is, bits before encoding) is copied and combined with the second message. The combined message is encoded into a second codeword.

The bits from the first message can be directly copied and appended to the second message;

The bits from the first message can be transformed (multiplying with a binary matrix for example) and appended to the second message.

Although information bit (message) coupling is presented as an example, it is also feasible to use coded bits for coupling. In the case of systematic codes, message bits are also part of the code bits, and thus the two alternatives become the same.

A first potential application scenario is described as follows. A device (robot arm, for example) communicates with a BS and supports URLLC, eMBB and mMTC services. The video surveillance data transmissions belong to eMBB service, the signaling for controlling joints belongs to URLLC service, and some delay-insensitive sensing/monitoring data report belongs to mMTC.

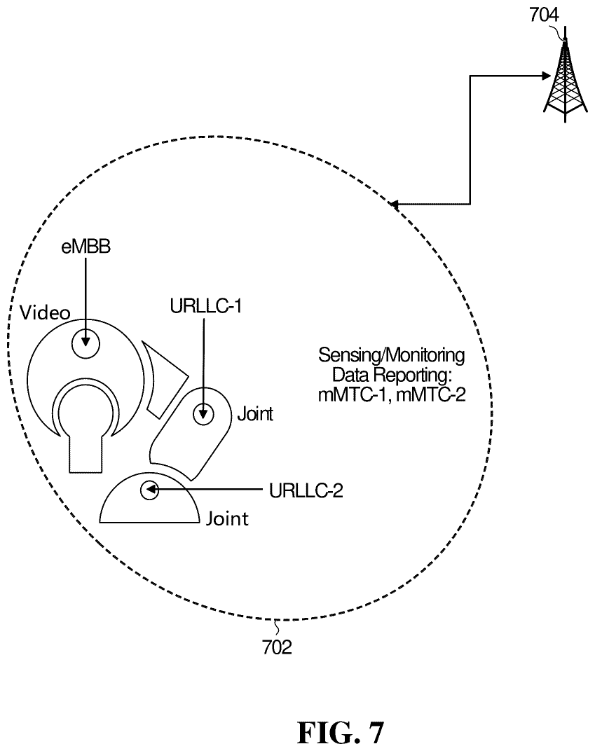

FIG. 7 is a block diagram illustrating this example, in which a robot arm 702 includes a video device and two joints, and communicates with a BS 704.

According to an approach that may be referred to as augmented eMBB coding, a joint code block comprises symbols/bits corresponding to URLLC, eMBB and mMTC packets. Each URLLC, eMBB, or mMTC packet is self-decodable. Typically, URLLC bits/symbols are placed in the beginning of the code block, followed by eMBB bits/symbols, and then mMTC bits/symbols.

A decoder first attempts to decode the short packets, which in this example may be URLLC packets. If the URLLC packet can be successfully decoded, its coupled bits in the eMBB packets can augment the decoding of the eMBB packet(s). The decoder can choose either to decode the eMBB packet, or the mMTC packets next. If the eMBB packet is decoded next and is successfully decoded, then the mMTC packets can be decoded with lower error probability; otherwise if the mMTC packets are decoded next and are successfully decoded, then the eMBB packet can be decoded with even lower probability.

The augmented decoding of a second packet after the successful decoding of a first packet is due to the coupling of information bits or coded bits between the two packets. In the case of coupled information bits, the, the other packet will have fewer information bits but its packet length remains the same, which means lower code rate. In the case of coupled coded bits, the, the other packet will have shortened code bits which are pre-known to the decoder, which also means lower code rate. In both cases, the code rate of at least another self-decodable codeword (eMBB for example) can be reduced, therefore resulting in an improved performance.

In the example above, code bits that are pre-known are code bits that are known from decoding the first packet.

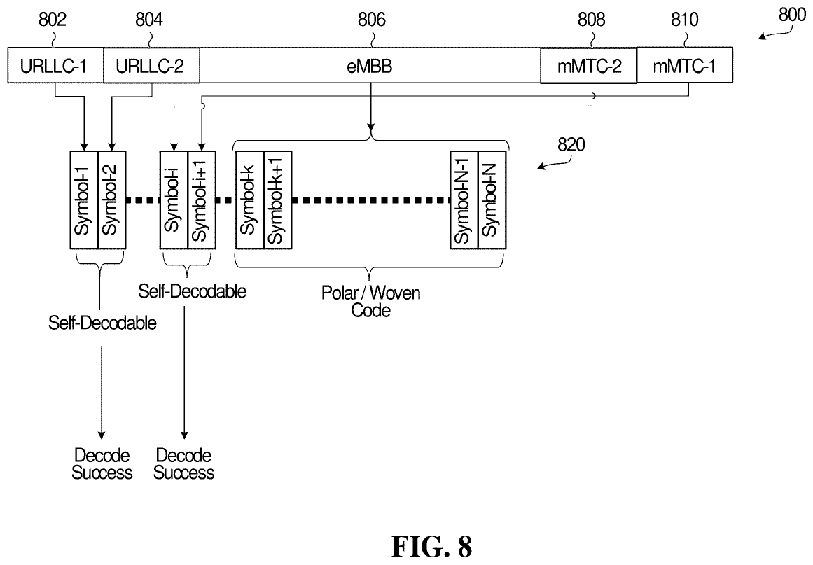

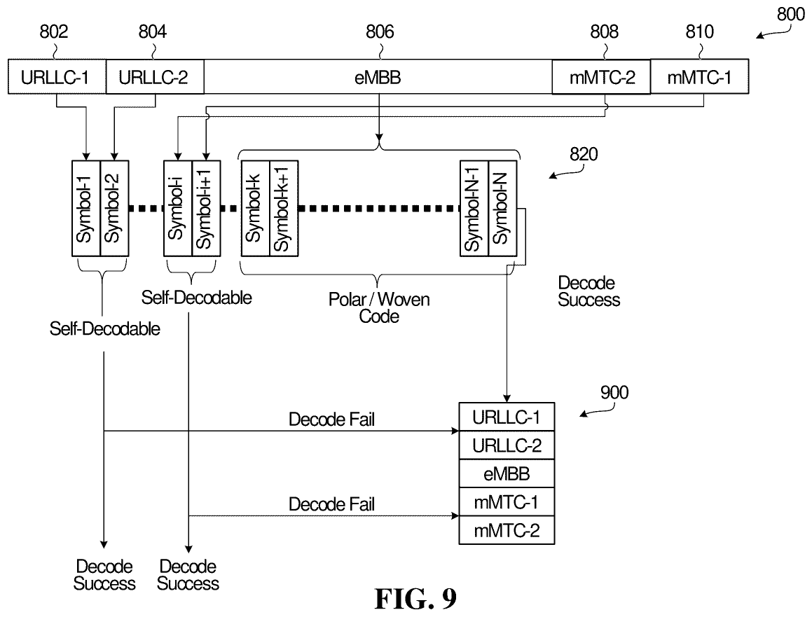

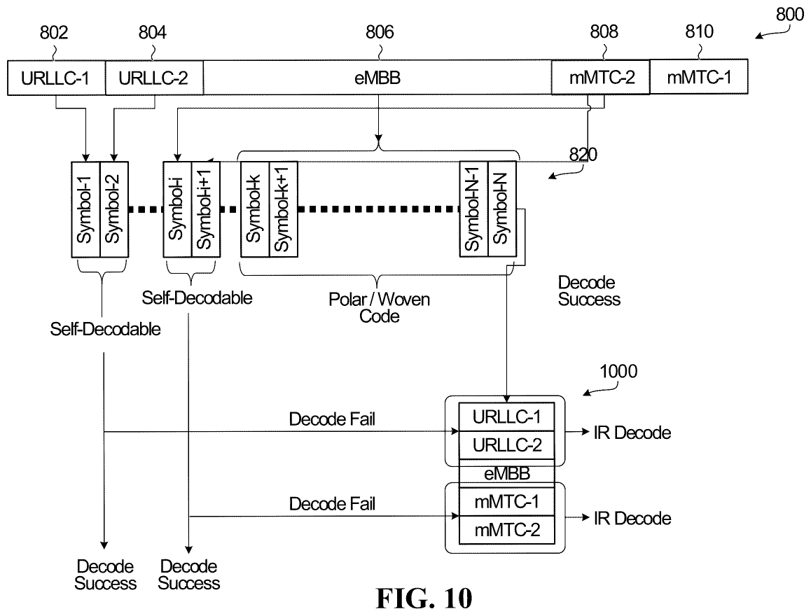

FIG. 8 is a block diagram illustrating an example code block and encoded symbols. In FIG. 8, and similarly in FIGS. 9 and 10 described below, 800 represents a code block or combined payload that includes individual payloads 802, 804, 806, 808, 810. The individual payloads 802, 804, 806, 808, 810 include payloads that are associated with different services in the example shown. The code block 800 is channel encoded to generate a codeword 820 for transmission. The codeword 820 is generated by encoding the individual payloads with an error correction code. Polar code or woven code is illustrated for the eMBB individual payload as an example. Other codes, including different codes for different individual payloads, are possible. The codeword 820 is also shown as comprising N symbols, but symbols are intended solely as an illustrative example of parts of a codeword. The arrangement of symbols shown at 820 is also an example that is intended to illustrate one possible decoding order. FIG. 8, and similarly FIGS. 9 and 10, should be interpreted accordingly.

A code block as shown at 800 may be referred to as a combined or joint code block, because it includes individual payloads, blocks, or bits, which correspond to URLLC, eMBB and mMTC services in the example shown. The URLLC, eMBB, and mMTC encoded symbols represent transmitted or received information about code bits, which are part of a codeword. The encoded symbols may be referred to by any of various names or terms, such as packets, blocks, codes, sub-codewords, signals, LLRs, resource elements (REs), etc. For ease of reference, the present disclosure refers primarily to encoded symbols or encoded blocks in referring to parts of a codeword.

In the codeword 820, the URLLC, eMBB, and mMTC encoded symbols are self-decodable. Once code bits for each encoded symbol are received, that symbol can be decoded even though, in the case of the URLLC and the mMTC encoded symbols in the example shown, the entire codeword 820 has not yet been received. A self-decodable symbol may be decoded independently from other encoded symbols, in a first decoding attempt for example, and is also jointly-decodable with one or more other encoded symbols, which may (but need not necessarily be) self-decodable symbols, as disclosed herein.

Self-decodable and jointly-decodable may be referenced in the context of data before or after channel coding. For example, a short code or block that is part of a longer codeword may be considered self-decodable in that the block is decodable on its own, independently of the remainder of the longer codeword. The data that was encoded to generate that short code or block, also referred to herein as an individual payload for example, may be considered self-decodable in that the individual payload is self-decodable from the short code or block. Whether in the context of unencoded payloads or encoded symbols or packets, for example, decodable is intended to mean the same thing, specifically that individual payloads and a combined payload can be decoded from a codeword, or equivalently a codeword can be decoded to recover individual payloads and a combined payload. In other words, a payload (information bits) and a coded block or packet (code bits) can be deterministically transformed to/from each other. A payload/information bits or a code packet/code bits may be referred to as being decodable, or as being encodable.

In FIG. 8 for example, URLLC individual payloads 802, 804 are placed in the beginning of the code block 800, so that these delay-sensitive payloads may be decoded first, followed by an eMBB individual payload 806, and then mMTC individual payloads 808, 810.

At a receiver, a decoder first attempts to decode the URLLC encoded symbols or short packets, labelled Symbol-1 and Symbol-2 in FIG. 8. For illustrative purposes, the URLLC individual payloads are shown as being encoded into respective self-decodable encoded symbols, but in other embodiments encoding is based on service type, and 802, 804 are treated as one individual payload and are self-decodable together as one individual payload. If a URLLC packet can be successfully decoded, then URLLC bits, from that packet or the individual payload decoded from that packet, can assist or augment decoding of one or more other packets, or more generally one or more other blocks or sub-codewords of the long codeword 820. For example, encoded or decoded URLLC bits may be coupled in the eMBB individual payload 806, and/or in the eMBB encoded packet(s), including Symbol-k, Symbol-k=1, . . . , Symbol-N-1, Symbol-N in the example shown. The coupled bits can augment decoding of the eMBB packet(s). After URLLC decoding, the decoder may then either decode the eMBB packet(s), or decode the mMTC packet(s), including Symbol—the and Symbol-i+1 in the example shown. If the decoder attempts to decode the eMBB packet(s) after URLLC decoding and the eMBB decoding is successful, then the mMTC packet(s) can be decoded with lower error probability based on any coupled eMBB bits. Otherwise, if decoding of the mMTC packet(s) is attempted after URLLC decoding and are successfully decoded, then the eMBB packet(s) can be decoded with even lower probability based on any URLLC and/or mMTC bits coupled in the eMBB individual payload 806 or the eMBB packet(s). In the example shown in FIG. 8, the arrangement of encoded packets at 820 illustrates an embodiment that supports URLLC decoding, then mMTC decoding, and then eMBB decoding, but this is not the only possible decoding order.

Augmented decoding of a second packet, which may include one or more eMBB packets in the examples above, after the successful decoding of a first packet, which may include one or more URLLC packets and/or one or more mMTC packets in the examples above, is enabled by coupling of information bits and/or encoded bits between individual payloads and/or packets. In the case of coupled information bits, for example, a packet for which decoding is augmented will have been generated from fewer information bits of an individual payload, but the packet length remains the same, which results in a lower code rate. In the case of coupled code bits, a packet for which decoding is augmented will effectively have shortened code bits that are pre-known to the decoder, which also in effect results in a lower code rate. In both cases, whether information bits, coded bits, or both are coupled between packets, the code rate for augmented decoding, of eMBB packet(s) in the examples described with reference to FIG. 8, can be reduced. This can provide improved decoding performance by increasing the probability of successful decoding.

It should be noted that the packet(s) for which inter-packet coupling provides or supports augmented decoding may also be self-decodable. Coupling of bits between packets does not mean that augmented decoding must rely on prior successful decoding of coupled bits. For example, the eMBB packets(s) in the examples described with reference to FIG. 8 may be self-decodable regardless of whether decoding of the URLLC and/or mMTC packets was successful.

In an approach that may be referred to as HARQ-less URLLC, one option is that if a self-decodable packet (URLLC for example) fails to decode, instead of requesting a retransmission, the receiver proceeds to decode another self-decodable packet (eMBB for example). If the latter self-decodable codeword is successfully decoded, the code rate of the former can be reduced, resulting in improved performance. The other option is that if a self-decodable packet (URLLC for example) fails to decode, instead of requesting a retransmission, the receiver proceeds to jointly decode the entire code block consisting of URLLC, eMBB and mMTC. If the joint codeword is successfully decoded, all the bits can be correctly recovered.

The entire code block consists of URLLC, eMBB, and mMTC in FIG. 9 (discussed below), but this an illustrative and non-limiting example.

There are also two modes for coupling between URLLC symbols and eMBB symbols. The first is referred to herein as “tight coupling” but may also be known by other names. In tight coupling, the coupling is within one slot or code block. The second is referred to herein as “loose coupling” but may also be known by other names. In loose coupling, the coupling is between two consecutive slots or code blocks.

FIG. 9 is a block diagram illustrating an example code block and encoded symbols. The code block 800 and encoded symbols 820 are the same as those shown in FIG. 8, but FIG. 9 illustrates different decoding at 900, as an example of HARQ-less URLLC. If a self-decodable packet (for URLLC for example) fails to decode, then instead of requesting a retransmission, the receiver may proceed to decode another self-decodable packet (for eMBB or mMTC, with mMTC being shown as an example in FIG. 9). If the latter self-decodable packet is successfully decoded, then the code rate of the former packet can be reduced based on coupled bits from the latter packet, resulting in improved performance. Another option is that if a self-decodable packet (for URLLC for example) fails to decode, then instead of requesting a retransmission, the receiver may proceed to jointly decode the entire joint codeword 820 to recover the entire code block 800. If the joint codeword 820 is successfully decoded, then all of the bits at 800 can be correctly recovered. In one example shown in FIG. 9 at 900, if both URLLC decoding and mMTC decoding fail, then joint decoding can still be successful.

Tight coupling within one time slot or one combined or joint code block 800 is shown in FIG. 9. To enable joint decoding, there is coupling between individual payloads or encoded blocks within one code block 800 or codeword 820. Tight coupling may be preferred, for example, because it enables joint decoding based on a single slot or parts of a single joint codeword rather than multiple slots or parts of multiple codewords.

In an approach that may be referred to as HARQ-less URLLC with IR combining, if the above second decoding attempts fails again, the receiver requests retransmission using incremental redundancy HARQ. The retransmission contains the incremental code bits for the first message (URLLC in this example), because a successful decoding of the first message will increase the chance of successful decoding for subsequent messages. Optionally, the retransmission may contain incremental code bits for the subsequent messages as well, in order to further enhance decoding performance.

After receiving the retransmitted bits/symbols, the receiver will perform similar decoding attempts as mentioned above.

FIG. 10 is a block diagram illustrating another example code block and encoded symbols. The code block 800 and encoded symbols 820 are the same as those shown in FIGS. 8 and 9, but FIG. 10 illustrates different decoding at 1000, as an example of HARQ-less URLLC with incremental redundancy (IR) combining. In some embodiments, there may be multiple decoding attempts without requesting retransmission, such as shown in FIGS. 8 and 9 above, and if those decoding attempts fail, then a receiver may request retransmission using incremental redundancy HARQ. This type of approach may still be referred to as “HARQ-less” in the context of the multiple decoding attempts before a first retransmission request is transmitted by a receiver and received by a transmitter, and HARQ-less URLLC with IR as referenced above adds the option of a retransmission request after multiple unsuccessful decoding attempts.

A retransmission preferably contains incremental redundancy information such as incremental code bits for the first message (URLLC in the example shown in FIG. 10), because successful decoding of the first message will increase the chance of successful decoding of subsequent messages. Optionally, the retransmission may also or instead contain incremental redundancy information such as incremental code bits for the subsequent messages, in order to further enhance decoding performance. IR decoding based on incremental codes bits is generally indicated at 1000 by “IR Decode”, for both URLLC and mMTC in the example shown.

After receiving the retransmitted code bits, the receiver may perform similar decoding attempts as described by way of example above.

Regarding requests and retransmission, consider a conventional HARQ approach, which is enabled by ACK and/or NACK signaling, and up to four redundancy versions (RV₁, RV₂, RV₃, RV₄) for retransmission options. NACK signaling may be considered a form of retransmission request, in response to which a retransmission that includes a redundant version of previously transmitted data is sent by a transmitter. In this type of approach, a NACK would be sent by a receiver after a first decoding failure.

A second decoding attempt (“HARQ-less”) is made before retransmission is requested, via NACK signaling or otherwise. This may involve behaviors or features at either or both of an encoder/transmit device and a decoder/receive device.

In these NACK/NACK-2 examples, whether to request retransmission using NACK or NACK-2 is left for a decoder or receiving device to decide. A device can potentially send both NACK and NACK-2 after multiple decoding failures, or entirely skip the NACK for the first decoding failure and not send NACK at all. How to exploit the difference between NACK and NACK-2 is left for the transmit device to decide. It can prioritize retransmission for NACK-2 in the case of resource constraints, for example, or treat NACK and NACK-2 equally in the case of sufficient resources.

In these NACK/NACK-2 examples, whether to request retransmission using NACK or NACK-2 is left for a decoder or receiving device to decide. A device can potentially send both NACK and NACK-2 after multiple decoding failures, or entirely skip the NACK for the first decoding failure and not send NACK at all. How to exploit the difference between NACK and NACK-2 is left for the transmit device to decide. It can prioritize retransmission for NACK-2 in the case of resource constraints, for example, or treat NACK and NACK-2 equally in the case of sufficient resources.

Retransmission procedures may also or instead be different. For example, in addition to, or instead of, redundant versions RV₁ to RV₄ in the conventional HARQ approach outlined above, there may be one or more new redundant versions or joint retransmission versions to indicate whether a retransmission is a standalone RV (as in the conventional example above), or embedded in an incoming payload or packet (for example, in an incoming eMBB packet to enable joint decoding of a URLLC packet or payload) through joint coding. This latter type of embedded retransmission may be referred to as a joint retransmission version or J-RV, for example, to enable a decoder or receive device to determine whether a retransmission is a standalone RV or a J-RV.

FIGS. 8 to 10, like other drawings herein, provide illustrative and non-limiting examples. Variations are possible. For example, individual payloads for different packets can be ordered according to any of various criteria, such as their priority or urgency. It may be preferable to decode individual payloads for more urgent services such as URLLC first, and accordingly those individual payloads may be at the beginning of a combined payload as shown. Code bits for those individual payloads will then be transmitted, received, and decoded before others.

Other criteria may also or instead be taken into account. For example, individual payloads and/or corresponding packets can be ordered according to data or packet size. Packets for smaller messages (fewer information bits) or fewer coded bits, for example, can be placed, transmitted, and received/decoded first. This may enable a smaller decoding LLR buffer because the first-received packets can be quickly decoded and the corresponding LLRs can then be flushed from the buffer.

There are several possible ways to perform self- and joint-coding. For example, the packets can be coupled in a chain-like structure, or coupled in a star-like structure.

Self- and joint-coding may include or involve self-decoding and joint-decoding, which may be provided or supported in any of various ways. Packets are referenced in the examples above, but more generally payloads or packets can be coupled according to a sequence or chain structure, or coupled in a star structure, for example.

The first approach is referred to herein as successive embedding. The encoding procedures are as follows:
Take K₁ information bits (URLLC for example) and encode into N₁ code bits, the code rate is R₁=K₁/N₁
Take the K′, bits (from the K₁ bits, so K′₁≤K₁) and K₂ additional bits (eMBB for example), K′₂=K′₁+K₂, and encode into N₂ code bits—the code rate is R₂=K′₂/N₂>R₁
Take the K″₂ bits (from the K′₂ bits, so K″₂≤K′₂) and K₃ additional bits (mMTC for example), K″₃=K″₂+K₃, and encode into N₃ code bits—the code rate is R₃=K″₃/N₃>R₂
And so on: more payloads can be included in the above fashion.

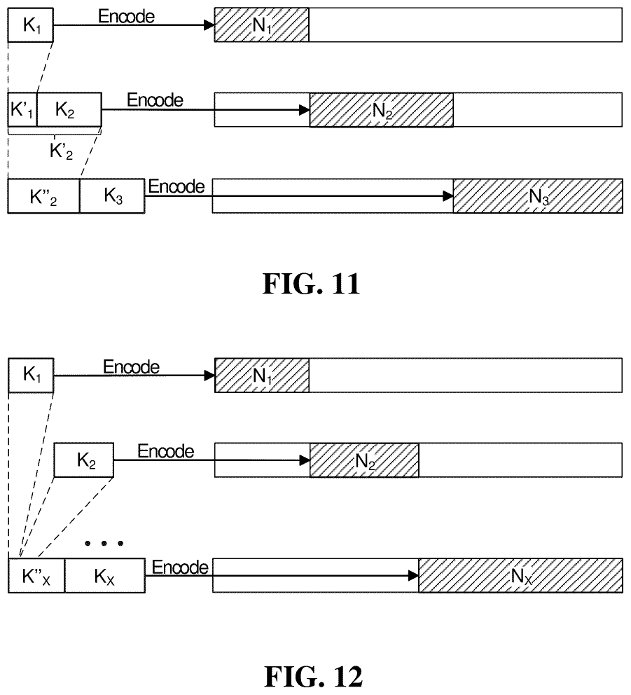

These encoding procedures are illustrated in FIG. 11.

FIG. 11 is a block diagram illustrating sequential coupling of bits between individual payloads, according to a sequence or chain structure. This type of encoding approach to provide or support self-decoding and joint-decoding may also or instead be referred to as successive embedding, to capture the notion that information bits from one individual payload are embedded or otherwise combined with information bits of another individual payload.

In the example shown in FIG. 11, K₁ information bits (associated with a URLLC service, for example) are encoded into N₁ code bits, for a code rate of R₁=K₁/N₁. Of the K₁ information bits, K′₁ bits (K′₁≤K₁) are prepended to K₂ additional bits of a different individual payload (for eMBB for example). Embedded bits may be prepended as shown, but in other embodiments embedded bits may be appended to or otherwise combined with information bits of a different individual payload. The combined K′₂=K′₁+K₂ bits are encoded into N₂ code bits, for a code rate of R₂=K′₂/N₂>R₁. K″₂ bits from the K′₂ (K″₂≤K′₂) are embedded, by prepending in the example shown, with K₃ additional bits from a different individual payload (for mMTC for example), and the resultant K″₃=K″₂+K₃ bits are encoded into N₃ code bits. The code rate is R₃=K″₃/N₃>R₂. A joint codeword includes the N₁ code bits, the N₂ code bits, and the N₃ code bits. This type of sequential or successive embedding may be repeated for more individual payloads, or in some embodiments there may be fewer than three individual payloads.

The second approach is referred to herein as multi-to-one embedding. The encoding procedures are as follows:
Take K₁ information bits (URLLC for example) and encode into N₁ code bits, the code rate is R₁=K₁/N₁
Take K₂ information bits (mMTC for example) and encode into N₂ code bits, the code rate is R₂=K₂/N₂
And so on: more payloads can be encoded into packets in the above fashion
Take the K′₁ bits (from the K bits, so K′₁≤K₁), the K′₂ bits (from the K₂ bits, so K′₂≤K₂), and others to combine into K″ₓ bits. Gather the K″ₓ bits and the Kₓ additional bits (eMBB for example) into K′ₓ=K″ₓ+Kₓ bits, and encode into Nₓ code bits—the code rate is Rₓ=K′ₓ/Nₓ>R₁, Rₓ>R₂, and so on.

The encoding procedures are illustrated in FIG. 12.

FIG. 12 is a block diagram illustrating what may be referred to as multi-to-one coupling of bits between individual payloads, according to a star structure. This type of encoding approach to provide or support self-decoding and joint-decoding may also or instead be referred to as multi-to-one embedding, in which information bits from multiple different individual payloads are embedded or otherwise combined with information bits of one other individual payload.

In the example shown in FIG. 12, K₁ information bits (associated with a URLLC service, for example) are encoded into N₁ code bits for a code rate of R₁=K₁/N₁, and K₂ information bits (associated with an mMTC service, for example) are encoded into N₂ code bits for a code rate of R₂=K₂/N₂. This may be repeated if there are more than two individual payloads to be coupled to another individual payload. K′, bits of the K, information bits (K′₁≤K₁), K′₂ bits of the K₂ information bits (K′₂≤K₂), and some or all information bits of any other individual payloads that are to be coupled, are embedded with Kₓ additional bits of a different individual payload (for eMBB for example). Embedded bits may be prepended as shown, but in other embodiments embedded bits may be appended to or otherwise combined with information bits of a different individual payload. The combined K′ₓ=K″ₓ+Kₓ bits are encoded into Nₓ code bits, for a code rate of Rₓ=K′ₓ/Nₓ>R₁, Rₓ>R₂, and so on.

FIGS. 11 and 12 illustrate examples of coupling, in which one or more common bits couple one or more self-decodable encoded blocks with one or more other encoded blocks. In FIG. 11, common bits are successively embedded, between respective individual payloads that are encoded to generate a self-decodable encoded block (the K₁-bit block for example) and one or more other encoded blocks in a codeword, according to a sequence of the respective individual payloads in a combined payload corresponding to the codeword. In FIG. 12, the common bits are embedded, into one individual payload (at the bottom of FIG. 12 in the example shown) that is encoded to generate one encoded block, from respective individual payloads that are encoded to generate a self-decodable encoded block (the K₁-bit block for example) and another encoded block (the K₂-bit block for example).

These are examples only, and other types of coupling between individual payloads and/or encoded packets are possible, including a coupling approach that combines the sequential or successive coupling of FIG. 11 with the multi-to-one coupling of FIG. 12. For example, in such a mixed coupling approach, a first individual payload may be encoded according to sequential coupling and a second individual payload may be encoded according to multi-to-one coupling, or vice-versa.

Coupling is not in any way limited to common bits between different individual payloads, and common bits may also or instead be common to encoded blocks. For example, in an approach similar to the example in FIG. 11 but applied to coded bits, common bits may be successively embedded between a self-decodable encoded block (the N₁-bit block for example) and one or more other encoded blocks according to a sequence of the self-decodable encoded block and the other encoded block(s) in a codeword. Similarly, considering multi-to-one coupling of encoded blocks, common bits may be embedded, into one encoded block (the Nₓ-bit block at the bottom of FIG. 12 for example) that is encoded to generate one encoded block, from the self-decodable block (the N₁-bit block for example) and one or more other encoded blocks (such as the N₂-bit block for example).

As another example, embedding may be applied between only some and not all individual payloads, and/or a combination of these two approaches may be applied.

Variations in encoding of information bits are also possible.

In encoding information bits in FIGS. 11 and 12, all information bits may be encoded using the same or similar types of codes, or different codes may be used for different individual payloads. This may also or instead be applied more generally to coding of individual payloads.

A common code type for all individual payloads may be more suitable for coupling between individual payloads or packets. Soft-output iteratively decoded codes, for example, include convolutional codes, turbo codes, low density parity check (LDPC) codes, product codes, and woven codes. Any of these can be jointly decoded. For example, after decoding two codewords independently, soft information about shared/coupled bits can be exchanged (in an inter-code iteration) between two codes before further decoding. Hard-output successively decoded codes include polar codes, polarization-adjusted convolutional (PAC) codes, Reed-Muller (RM) codes, Bose-Chaudhuri-Hocquenghem (BCH) codes, and Reed-Solomon (RS) codes. These codes can also be decoded using joint successive cancellation. For example, after decoding one codeword, its shared/coupled bits can be cancelled from another codeword, and then that other codeword can be decoded. Because codes belonging to any one type have more compatible decoders, they are more conveniently decoded together. Therefore, it may be preferable to use codes of the same type (soft or hard) for individual payloads that are part of the same combined payload. However, it is also possible to use codes of different types.

### Base Station Scheduling Mixed Traffic Transmission in a Single Transport Block (TB)

When a BS is aware of that a UE needs to transmit multiple traffic, the BS may schedule a mixed traffic transmission in a single TB. It is proposed herein to use mixed traffic coding to jointly encode the multiple traffic data.

After the UE sends an (SR), which can be a mixed traffic SR or SRs sent separately for each traffic type, the BS can decide to send a DCI to schedule multiple traffic data transmission in one transmission, in one transport block (TB) transmitted in a PUSCH for example. For simplicity, in this example, we assume only two traffic types are used, one is URLLC traffic, the other is eMBB, although the scheme described can be used for different traffic types than the above two and can be used for joint encoding of more than two traffic types.

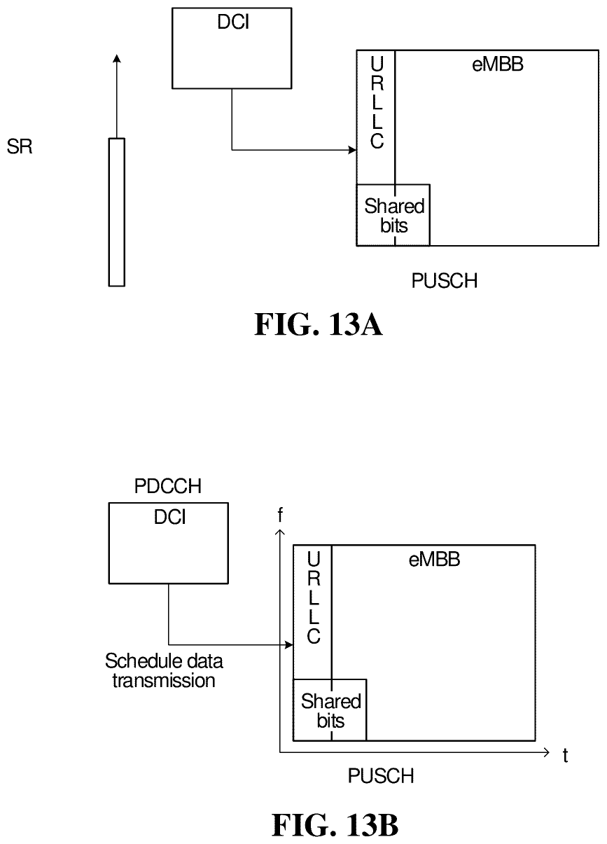

FIG. 13A illustrates such an example, which involves a scheduling request (SR), downlink control information (DCI) to schedule multiple traffic data transmission in one TB transmitted in a PUSCH.

Another example is shown in FIG. 13B. An SR is optional, and is not shown in FIG. 13B. For completeness, FIG. 13B also illustrates frequency and time axes.

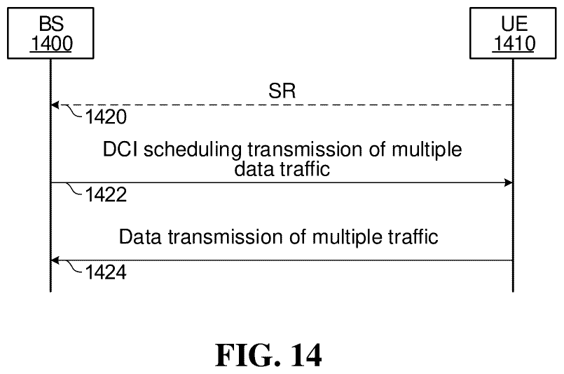

FIG. 14 is a signal flow diagram illustrating mixed traffic scheduling between a BS 1400 and a UE 1410. After the UE optionally sends an SR at 1420 (shown in dashed line form to illustrate that the SR is optional), the BS can decide to send DCI at 1422 to schedule multiple traffic data transmission in one transmission, such as in one TB transmitted in the examples shown in FIGS. 13A and 13B. The UE can then perform the data transmission of multiple traffic types at 1424, using the resources (which may be time-frequency resources as shown by way of example in FIG. 13B) that are assigned in the DCI.

The DCI sent to schedule a mixed traffic coding can include the following fields in order to provide all the information for UE to perform mixed traffic coding:
1. 1 bit to indicate to the UE whether it is to perform mixed traffic coding. This may be optional if the UE, based on DCI format or RNTI information, is to perform mixed traffic coding.
2. List of traffic type, priority index or logical channel.

RNTI refers to radio network temporary identifier.

This DCI example is one illustrative example, and other embodiments may use similar fields, different fields, fewer fields, additional fields, or scheduling that does not involve DCI.

A traffic type list may indicate which traffic data are used for joint encoding for each traffic type. In the case of mixed traffic encoding for two traffic types, two of the traffic type/service/priority index are indicated. These indications can follow a fixed order (from lower priority to higher priority or vice versa, for example). The information to indicate which traffic data are used may not necessarily be a traffic type, it may be a list of priority index, which indicates a priority level that is associated with the traffic type or logical channel used; it may be a logical channel ID list or logical channel group ID list. Note that logical channel is just one example of association of the data with its priority, traffic type or QoS, in some other scenarios, this field may be associated with QoS value, priority that is used for other layers instead or in addition of logical channel. For example, 5G Quality of Service (QOS) has been defined in higher layer (application layer for example), which may be associated with this priority/service index list field.

### Coupling Ratio

Some embodiments herein involve coupling.

Coupling ratio indicates the ratio of shared payloads/payload of the high priority traffic. For example, if there are two traffics of URLLC and eMBB traffic, then when we use mixed traffic coding, we encode URLLC traffic using a small code (same as the scenario without mixed traffic coding), and part of the URLLC payload is shared and embedded together with the eMBB payload and jointly encoded using the large code used for eMBB encoding. The ratio of the shared payload over URLLC payload is the coupling ratio. In some scenario, there may be a default coupling ratio that is not needed to be signaled in DCI. For example, if all the URLLC payload is always imbedded into eMBB payload for joint encoding, the coupling ratio is default to 1 or 100%.

The coupling ratio example above indicates a ratio, but this may be described as or indicated as a portion of shared payload(s) to another payload. Signaling of a coupling ratio in DCI is also an example. Coupling may be signaled in other ways. A default coupling ratio of 1 or 100% is an example as well. Other default coupling ratios are also possible.

### Resource Ratio

Resource ratio is another parameter that may be used in some embodiments.

Resource ratio indicates ratio of resource mapped for each traffic over the total resource used for the TB. In some scenarios, as the URLLC traffic may be occupying a number of symbols in the beginning of the assigned resources, the resource ratio may be indicated implicitly by indicating the number of symbols used for the higher priority traffic (URLLC in this example). In some other scenarios, the resource ratios may indicate the number of PRBs for the URLLC service over the total number of PRBs.

The foregoing provides an example of resource ratio. More generally, resource ratio may indicate ratio or portion of the resource(s) mapped for any (or each) traffic type to total resource(s) used for a mixed traffic transmission (for a transmission of one TB for example). In some scenarios, one type of traffic (URLLC traffic for example) may occupy a number of symbols in the beginning of assigned resources, and the resource ratio may be indicated implicitly by indicating that number of symbols. In other scenarios, resource ratios may indicate the number of physical resource blocks (PRBs) for traffic types, such as a number of PRBs for the URLLC traffic associated with a URLLC service in this example, over the total number of PRBs. Other options for indicating resource ratio are also possible.

### MCS for Each Traffic Type

This is the target MCS for each traffic type. the same modulation can be shared, the same or different MCS tables may be used for each traffic type.

MCS refers to modulation and coding scheme. Some embodiments may provide or support MCS for each traffic type.

### Base Station Scheduling Mixed Traffic Transmission in Separate Transport Blocks (TBs)

Base station scheduling of mixed traffic transmission in a single TB is referenced above. Scheduling of mixed traffic transmissions in separate TBs is also possible.

Another way for a BS to schedule the mixed traffic transmission is to schedule separate transmissions for different traffics. Separate TBs can be used to transmit URLLC and eMBB traffic. Each belongs to its own TB, and is scheduled by its own DCI, and time frequency and other resources are separately scheduled for each traffic. For example, two TBs may be scheduled separately for eMBB and URLLC transmission, however, joint mixed traffic coding is still applied for the two traffic types. For example, in the eMBB transmission, some of the payload of URLLC may still be embedded into the eMBB payload for joint coding in the eMBB transmission.

In this scenario, the time frequency resource is separately scheduled, then there is no need to indicate resource ratio. If only URLLC information bits are embedded into eMBB, then there is no additional information needed for scheduling the URLLC transmission because the coding procedure is the same as if there is no mixed traffic coding. However, for the eMBB scheduling, in DCI, additional information related to performing mixed traffic coding by embedding URLLC payload into eMBB payload for joint encoding may be provided. The additional information may include:
1. 1 bit to indicate to inform the UE whether it is to perform mixed traffic coding. This can be indicated for both eMBB and URLLC transmission, or only indicated for the eMBB transmission where joint encoding is used.
2. Service index/priority index/logical channel ID or IDs or group ID for the scheduled transmission. This will be different for the URLLC DCI and the eMBB DCI.
3. Coupling ratio. This can be indicated for both eMBB and URLLC transmission, or only indicated for the eMBB transmission where joint encoding is used.
4. Information to identify the other (coupling) TB or traffic used for joint encoding. This can be indicated for both eMBB and URLLC transmission, or only indicated for the eMBB transmission where joint encoding is used.

The example above illustrates that each traffic type may belong to its own respective TB, may be scheduled by its own DCI, and resources may be separately scheduled for each traffic type. Separate scheduling may use separate control channels and separate resources. As in other examples, URLLC and eMBB are referenced as traffic types, but features may also or instead be applied to other traffic types, including more than two traffic types.

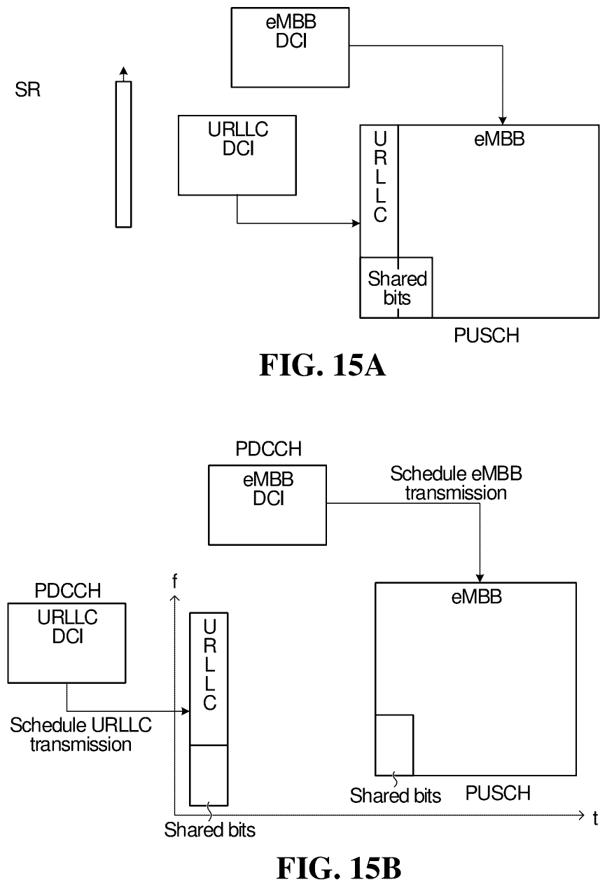

FIG. 15A illustrates an example that involves both a DCI scheduling URLLC resources and a DCI scheduling eMBB resources.

Another example is shown in FIG. 15B. An SR is optional, and is not shown in FIG. 15B. Scheduling (using DCI and PDCCH) and resources are shown separately in FIG. 15B, and for completeness, FIG. 15B also illustrates frequency and time axes.

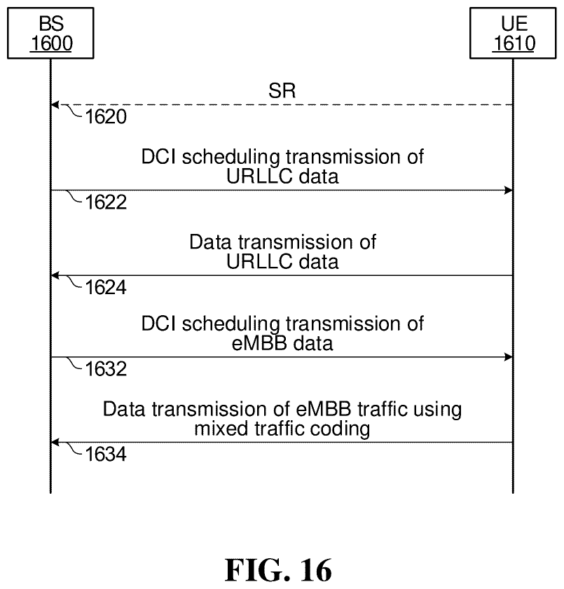

FIG. 16 is a signal flow diagram illustrating mixed traffic scheduling, with separate scheduling of different traffic types, between a BS 1600 and a UE 1610. for such operation. After the UE optionally sends an SR at 1620 (shown in dashed line form to illustrate that the SR is optional), the BS can decide to send DCI at 1622 to schedule transmission of URLLC data. The UE can then perform the data transmission of URLLC traffic at 1624, using the resources (which may be time-frequency resources as shown by way of example in FIG. 15B) that are assigned in the DCI at 1622. The BS can also decide to send DCI at 1632 to schedule transmission of eMBB data, and the UE can then perform the data transmission of eMBB traffic at 1634, using mixed traffic coding and the resources (which may be time-frequency resources as shown by way of example in FIG. 15B) that are assigned in the DCI at 1632.

### CB Segmentation and CBG Partitioning

A summary of this example includes:

In NR, TBs are segmented into multiple CBGs, and CBGs are equally divided among CBs.

In mixed traffic case, each traffic type perform CB segmentation separately. In other words, CB segmentation for each traffic type may be performed separately.

Maximum CB size can also be traffic dependent. For example, URLLC may have a smaller maximum CB size to allow for quick decoding, while eMBB may have larger maximum CB size. These maximum CB size can be configured and associated with priority index indication in DCI.

Each traffic type has its own CBG/CBGs to facilitate separate feedback and retransmission of each traffic using a (possibly pre-existing) CBG-based feedback mechanism.

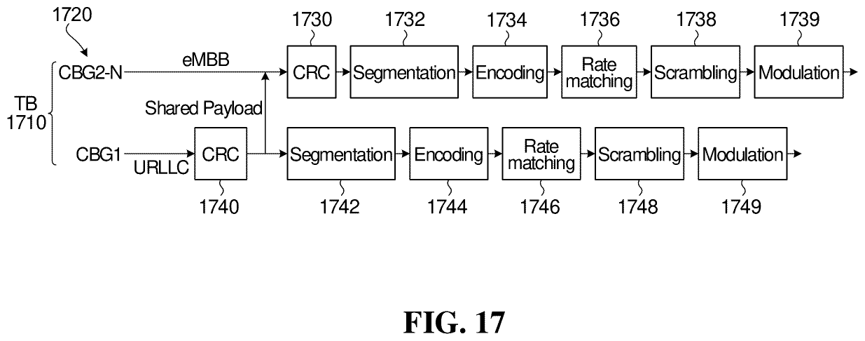

FIG. 17 illustrates a CB segmentation procedure for mixed traffic coding in the same TB. FIG. 17 shows the procedure to perform CB segmentation for mixed traffic coding in a TB. A TB is segmented into multiple CBs, then each CB is encoded, rate matched, concatenated, then modulated and then resource mapped to MIMO layers, time and frequency for the transmission.

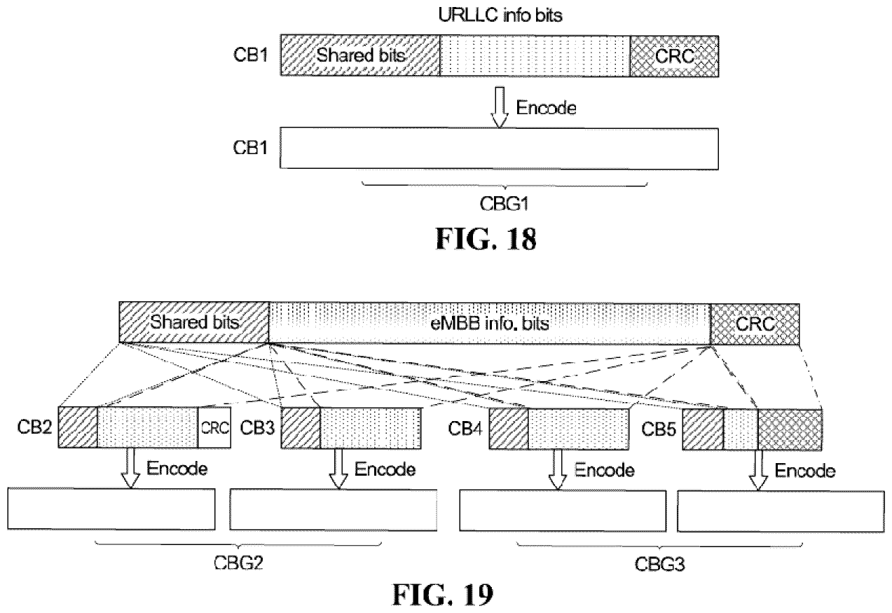

FIG. 18 illustrates a URLLC traffic encoding procedure. FIG. 19 illustrates an eMBB traffic encoding procedure. FIGS. 18 and 19 show some further details on the encoding procedure as well as CB segmentation and CBG partitioning for URLLC and eMBB traffic, respectively.

With the mixed traffic coding, if the URLLC traffic and eMBB traffic with mixed traffic coding are transmitted in the same TB, then there may be different ways to segment the TB into multiple CBs. Since the URLLC traffic and the eMBB traffic are encoded differently, it makes sense to have them segmented into different CBs rather than having the CB segmentation independent of traffic data.

A TB is shown at 1710, and is segmented into a number N of CBGs as shown at 1720.

The CB segmentation procedure shown in FIGS. 17 to 19 works as follows.

For URLLC traffic, a CRC will first be generated based on the information bits of URLLC traffic and be appended to the URLLC information bits. CRC is used for error detection, to check whether the corresponding information bits are decoded successfully or not. Part of the URLLC information bits will serve as shared bits and be embedded into eMBB information bits for joint encoding.

CRC refers to cyclic redundancy check. Generation of a CRC based on the information bits of URLLC traffic is shown at 1740. The part or subset of the URLLC information bits that serve as shared bits are shown as a shared payload in FIG. 17, and may be embedded into or otherwise combined with the eMBB information bits. In FIG. 17, the shared payload is taken from URLLC information bits after CRC. However, the shared payload can also be taken from URLLC information bits before CRC.

If the number of URLLC information bits is small, there may be no further segmentation needed. If the number of URLLC information bits is large, the URLLC information bits may be further segmented into multiple CBs, with each CB further having its own CRC added. Whether the information bits are segmented into multiple CBs may depend on the maximum CB size. If the number of URLLC information bits is larger than the maximum CB size, then segmentation into multiple CBs is performed. Segmentation may involve equally dividing the information bits into multiple CBs, and each CB is then encoded separately. After encoding of each CB, rate matching is performed based on selected RV and number of coded bits that the scheduled resource can carry. Then multiple CBs are concatenated into one bit-stream and scrambling is applied to the bit stream, then it is modulated into modulated symbols. The modulated symbols are then mapped to MIMO layers and time frequency resources for transmission. The mapping of modulated symbols to the resources may involve several steps: the modulated symbols can be mapped to L MIMO layers first, the symbols of the L MIMO layers are then precoded, and the precoded symbols are then mapped to time and frequency resources as well as antenna port for transmission.

Optional further segmentation of the URLLC information bits into multiple CBS (if the number of URLLC information bits is large) is shown at 1742. To avoid further congestion in the drawing, each CB is not shown its own CRC added. Whether the information bits are segmented into multiple CBs may depend on any of various factors or conditions, and maximum CB size is one example. Separate encoding of each CB is shown at 1744, and rate matching is shown at 1746. Concatenation into one bit-stream is not shown, in order to avoid further congestion in the drawing. Scrambling is shown at 1748, and modulation is shown at 1749. Mapping of modulated symbols to MIMO layers and time frequency resources for transmission as referenced above is an example. Other transmission methods or approaches are possible.

Similarly, for the eMBB traffic, the shared bits from the URLLC information bits are first added into eMBB information bits and a CRC is generated and appended based on both the shared bits and the eMBB information bits. In some scenarios, instead of using the URLLC information bits as the shared bits to add to eMBB data for encoding, the coded bits for URLLC may be used. The combined eMBB data with the shared URLLC bits is then segmented into one or multiple CBs depending on the maximum CB size. This procedure is similar to the URLLC counterpart. The information bits are then encoded and rate matched based on eMBB code rate, and concatenated into one coded bit stream, which is then scrambled and modulated into modulated symbols. The modulated symbols are further mapped to MIMO layers, time and frequency resources for transmission.

Generation of a CRC based on the shared bits and the eMBB information bits is shown at 1730 in FIG. 17. Segmentation into one or multiple CBs is shown at 1732, encoding is shown at 1734, and rate matching is shown at 1736. Concatenation into one bit-stream is not shown in FIG. 17. Scrambling is shown at 1738, and modulation is shown at 1739. As also noted above, mapping of modulated symbols to MIMO layers and time frequency resources for transmission is an example. Other transmission methods or approaches are possible.

In FIG. 17, the scrambling and modulation operation on the bit stream from URLLC and the bit stream from eMBB after code block concatenation are shown separately. In some embodiments, the scrambling, modulation and following operations such as resource mapping for the URLLC and eMBB traffics (or in general for multiple traffic types) may be conducted together (not shown in FIG. 17). In this scenario, after rate matching at 1736 and 1746 for URLLC traffic and eMBB traffic, respectively, the coded bits from multiple CBs from both URLLC traffic and eMBB traffic are concatenated into one coded bit stream, which contains both URLLC traffic and eMBB traffic, and then scrambling, modulation and resource mappings afterwards are applied to this one bit stream together.

In NR, each TB that contains multiple CBs may be grouped evenly into multiple CBGs with each CBG containing the same number of CBs and are the same size. However, for the mixed traffic coding scheme, it is desirable to have separate HARQ feedback for each specific traffic, because the different traffic may have different QoS requirements and have a different target BLER. Therefore, each traffic data can have its own HARQ feedback. However, instead of creating a separate mechanism to implement separate HARQ feedback for each traffic, it is proposed herein to portion the CBs into CBGs in a way that each traffic contains different CBGs, so that a CBG always belongs to a single traffic type. This way, by re-using a CBG based HARQ feedback mechanism, separate HARQ feedback for each traffic type can be achieved without introducing new HARQ feedback indications.

After receiving CBG based HARQ feedback, a BS or other network device, for example, can then schedule CBG based retransmission, such that the BS (in this example) may retransmit only CBGs that are not correctly decoded. Such CBGs can correspond to specific traffic type (or types). Note that CBG based HARQ feedback is usually used for downlink (DL) transmissions when UE is the receiver and send HARQ feedback to the BS. In uplink (UL) transmission, the BS is the receiver and responsible for scheduling retransmission and may not necessarily need to send the HARQ feedback to UE. In the UL scenario, CBG partitioning based on traffic type is still applicable and useful for the BS to schedule CBG based retransmissions. Thus, more generally, CBG based retransmissions, with or without HARQ feedback, may be useful for DL or UL communications.

The number of CBGs in a TB (N in FIG. 17) may be configured in advance, in RRC for example. To have traffic specific CBG partitioning, one method is to have a CB or CBs that belong to URLLC traffic always mapped to CBG1 and the rest of the CBGs (CBGs 2 to N) corresponding to the CBs of eMBB traffic. This is because URLLC usually contains a small amount of data while eMBB data amount is much larger. Another method is to assign approximately proportionally number of CBGs to each traffic type based on the number of information bits of each type, under the constraints that each traffic type is mapped to a positive integer number of CBGs and total number of CBGs is N. If the number of information bits for URLLC is very small, this may result in the same CBG partition as assigning CBG1 to URLLC.

As an example, there may be 2 CBs for URLLC traffic and 18 CBs for eMBB traffic after segmenting the payload of each traffic into CBs based on its maximum CB size, and the transmission is configured to have 4 CBGs. With traffic independent schemes, the total of 20 CBs will be segmented into 4 CBGs such that each CBG have 5 CBs, whereas with the traffic dependent division or segmenting, the first CBG will be corresponding to the 2 CBs of URLLC traffic, and the other 3 CBGs will each contains 6 CBs of eMBB traffic. In another example, if the URLLC traffic has 8 CBs and eMBB traffic has 12 CBs with 4 CBGs configured, then CBG1 and CBG2 may each contain 4 CBs of URLLC traffic and CBG3 and CBG4 may each contain 6 CBs of eMBB traffic. These are examples only, and other segmenting or partitioning approaches are possible.

Another idea for traffic aware CB segmentation is to assign traffic specific maximum CB size. This is due to the reason that each traffic type may have its own QoS requirement, which may lead to different preference of the CB size. For example, for URLLC traffic, a small CB size may be preferred such that it can be decoded quickly to reduce the delay, while for eMBB, a larger CB size may be preferable to maximize its coding performance because delay is not a significant consideration. Therefore, maximum CB size may be traffic dependent, for example URLLC traffic may use a smaller maximum CB size while eMBB traffic may use a higher maximum CB size. The traffic dependency may be realized through defining a maximum CB size for each traffic type.

Features that are referred to as being traffic aware (such as CB segmentation) may also be referred to as traffic based, traffic specific, or traffic dependent.

The association of traffic type and maximum CB size may be through the priority index indicated in DCI, the logical channel priority, the priority defined for 5G QoS, and so on. The association can be predefined or configured in RRC. For example, DCI can contain a field of priority index to indicate whether the data is high priority or low priority, then if it is indicated a high priority, the data may correspond to one maximum CB size while if it is low priority, the data can correspond to another maximum CB size. In some examples, the high priority maximum CB size can be smaller because it may correspond to a URLLC traffic while low priority maximum CB size can be larger because it may correspond to eMBB traffic. However, such correspondence may not always be the case. The traffic dependent maximum CB size can be used in the mixed traffic scenario as described in some examples herein, but it can also be applicable to the regular non-mixed traffic transmission scenario.

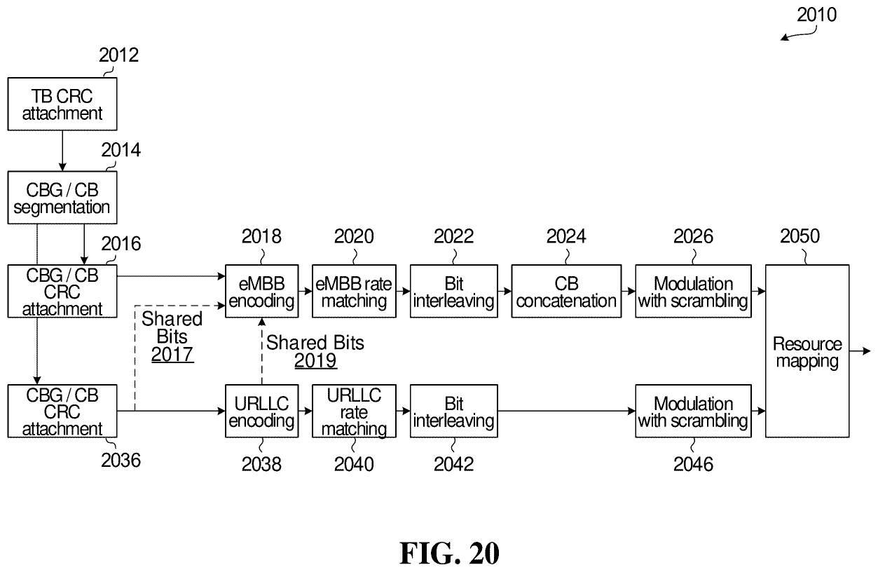

FIG. 20 is a block diagram of an example encoding chain according to an embodiment, and illustrates another possible option for implementing CB segmentation and mixed traffic coding as disclosed herein. The example encoding chain 2010 is for a URLLC-eMBB scenario, but as noted elsewhere herein other embodiments are possible.

The features or functions shown in FIG. 20 include TB CRC attachment at 2012, CBG/CB segmentation at 2014, CB/CBG CRC attachment at 2016, 2036 for each of eMBB traffic and URLLC traffic, encoding at 2018, 2038 for each of the eMBB traffic and the URLLC traffic, rate matching at 2020, 2030 for each of the eMBB traffic and the URLLC traffic, bit interleaving at 2022, 2032 for each of the eMBB traffic and the URLLC traffic, CB concatenation for the eMBB traffic at 20024 (may also be provided for the URLLC traffic in some embodiments), modulation with scrambling at 2026, 2036 for each of the eMBB traffic and the URLLC traffic, and resource mapping at 2050.

Other embodiments may include additional, fewer, or different elements interconnected in a similar or different way. For example, FIGS. 17 and 20 illustrate different ways to implement mixed traffic coding, and these example implementations include some common or similar elements with some, but not all, similar interconnections.

Encoding chain features or functions may be implemented in any of various ways, such as in hardware, firmware, or one or more components that execute software. The present disclosure is not limited to any specific type of implementation, and implementation details may vary between different devices, for example.

Shared bits to couple eMBB and URLLC traffic and codewords together at 2018, 2038 may be bits from the URLLC traffic as shown at 2017, or coded bits as shown at 2019. The resource mapping at 2050 may help ensure reliable and low-latency reception of URLLC symbols, for example by mapping URLLC traffic to frequency (subcarrier) and/or spatial (layer) resources that have better channel quality, and/or to time slots that are transmitted earlier. In some scenarios, the size of the shared bits is already taken into account in the CBG/CB segmentation process, by taking into account the size of shared bits together with the size of original eMBB payload for the size of overall eMBB payload for encoding purpose.

As an example, bits of the eMBB traffic in a CB after CB segmentation and CRC attachment may be denoted by e₀, e₁, . . . , e_{A-1}, where A is the number of payload bits. For the sake of simplicity, CB number is omitted in this notation. For URLLC, bits after CRC attachment may be denoted by u₀, u₁, . . . , U_{B-1}, where B is the number of payload bits. In an embodiment, a subset of the B bits associated with the URLLC payload bits, including C bits so that the subset is of size C, are copied and attached to the beginning of bits associated with the eMBB payload, at 2017 or 2019. This subset is also referred to herein as shared bits, common bits, or coupled bits.

Consider an embodiment in which the shared bits are bits before encoding, as shown at 2017. The new eMBB bits for encoding become u₀, u₁, . . . , U_{C-1}, e₀, e₁, . . . , e_{A}, which may be denoted as c₀, C₁, . . . , C_{C+A-1}. This is consistent with the example shown in FIG. 11.

Other features disclosed herein may be provided or supported in an implementation according to FIG. 20.

The implementations in FIGS. 17 and 20 are examples. Other implementations are possible.

### Shared Bits Distribution

Embodiments may involve any of various types or patterns of shared bits distribution.

A summary of this example includes the following:

Shared bits can be distributed evenly among all eMBB CBs and URLLC CBS.

Shared bits can have their own CRC (especially if self decodable).

For each CB, shared bits can be positioned in the most reliable bits depending on the code (such as small bit indices in Polar codes or higher degree variable nodes in LDPC codes).

Alternatively, shared bits can repeat on each eMBB CBs for maximum protection.

Shared bits can also be placed in a first eMBB CB or a first eMBB CBG only instead of all eMBB CBs.

Solution works for the case of shared TB separate TBs.

These are examples only, and the present disclosure is not limited to these example. Regarding even distribution, this is not limited to eMBB and URLLC CBs. Shared bits can be distributed evenly among CBs, which may also or instead include CBs of other types. Positioning based on reliability in the example above refers to small bit indices in Polar codes, but most reliable bits may be referred to as having lower bit indices, or may be most reliable according to an ordered sequence of bit indices in Polar codes. Repetition of shared bits is not limited to eMBB CBs as in the above examples, and more generally shared bits may be repeated in multiple CBs, which may or may not necessarily be eMBB CBs. Similarly, placement in a first CB or a first CBG is not limited to eMBB CBs, and more generally shared bits can be placed only in some but not all CBs for joint coding, such as in a first CB or only in a first CBG instead of in all CBGs.

As noted above, the foregoing solution works for the case of shared TB or separate TBs. More generally, these bit distribution features, and similarly other features or solutions disclosed herein, may work for and be applied to the case of a shared TB (a single TB with multiple traffic types) or separate TBs.

In the mixed traffic coding scenario, the shared bits or coupled bits between the two traffic types are distributed among different CBs. The shared bits can be distributed among different CBs of the same traffic type randomly among different CBs, which may not always give best performance. It is proposed herein to distribute shared bits evenly into multiple CBs for each traffic as shown in FIG. 19. This has the benefits of if any of the eMBB CBs is decoded successfully, then part of the shared bits will be decoded, which will help with decoding of URLLC.

The features and benefits of this example also apply more generally, beyond eMBB and URLLC. If any jointly decoded CB (an eMBB CB, such as CB2-CB5 in FIG. 19, is an example) is decoded successfully, then the shared bits in that CB will be decoded, and this will help with decoding of another CB that includes those shared bits (a URLLC CB, such as CB1 in FIG. 18, is an example).

For example, if there are 4 CBs for the eMBB traffic, the shared bits of different traffic can be divided nearly equally into 4 parts. Each part of the shared bits can be embedded into one CB of the eMBB traffic as shown in FIG. 19. Each CB then has its own CRC appended before encoding.

In the example shown in FIG. 19, there are 4 CBs for eMBB traffic. A CRC is shown by way of example in FIG. 17 for CB2, but more generally one or more CBs (all CBs or only some CBs) may have its own CRC generated and appended before encoding.

Similar division can be applied to shared bits in encoding of URLLC information bits if there are multiple CBs used for URLLC traffic (in the example of FIG. 18, there is only 1 CB for URLLC, therefore, no division of shared bits needed).

This even distribution of shared bits among CBs allows decoding of any of the eMBB CBs to result in successful decoding of a portion of shared bits, which further helps decoding of URLLC data.

There are other alternative ways to distribute shared bits among CBs. One is to repeat shared bits on each eMBB CB (and potentially each URLLC CB if there is more than 1 URLLC CB). This allows decoding of each eMBB CB to result in successfully decoding of all shared bits, which provides maximum help for further decoding of URLLC data. However, the drawback is the increased overhead of shared bits.

Another alternative shared bits distribution is to distribute shared bits only in one (a first for example) eMBB CB or one eMBB CBG for example). The benefit is that only the one eMBB CB or CBG's encoding is affected by the mixed traffic coding design and other CB/CBGs are unchanged. The drawback is that decoding of other eMBB CBs will not help decoding of URLLC data.

So The shared bits distribution method may depend on the application scenarios and required performance versus overhead tradeoff.

Application scenarios and required performance are examples of factors or conditions on which a shared bits distribution method or approach may depend. The way in which shared bits are distributed among CBs may also or instead be dependent on other factors or conditions.

In some scenarios, there is a CRC generated from shared bits and appended to the shared bits before embedding it into eMBB and/or URLLC data for encoding. This is such that it can be determined whether the shared bits are decoded successfully even if the overall URLLC or eMBB CB is not yet decoded successful. This is especially helpful if the shared bits are self-decodable even when jointly encoded with other information bits, for example, when used with Polar codes. However, CRC adds extra overhead, so in some scenario, CRC for shared bits may not be needed. When there is no CRC added for shared bits, decoding can rely on either exchange soft information on shared bits between an eMBB decoder and a URLLC decoder, to help decoding of each traffic or rely on a CRC for an entire CB to determine whether shared bits are decoded successfully in eMBB or URLLC traffic.

For each CB, shared bits can be positioned in the most reliable bits depending on the code. For example, shared bits can be put in the beginning, at small bit indices, in Polar codes. In another example, shared bits can be placed on the higher degree variable nodes in an LDPC code. In some other scenarios, there may be no specific treatment on position of the shared bits in all information bits. For example, shared bits may simply be placed in the beginning of the information bits, the end of the information bits or randomly among all the information bits for the encoding procedure.

The above described shared bits distribution method can work when URLLC and eMBB transmission share the same transport block (TB), but can also work if URLLC and eMBB data are transmitted in separate TBs.

### Examples of Traffic Aware Resource Mapping May Include

Resource mapping (time frequency and MIMO layers) should be traffic aware such that URLLC resources obtain the most reliable resources and/or the earliest resources. This illustrates how certain traffic types are preferably mapped to certain resources. Resource mapping order may be traffic dependent to best satisfy QoS requirements. The following are examples of features related to traffic dependent resource mapping.
For example, URLLC mapping order: MIMO layers-frequency-time; Minimum decoding delay. This example refers to minimum decoding delay, but this mapping order may provide at least lower or reduced decoding delay.
EMBB: MIMO layers-time-frequency; Maximum time diversity. This example refers to minimum decoding delay, but this mapping order may provide at least higher or increased time diversity.
The association of mapping order with traffic type may be configured in RRC, UE may use the priority indication in DCI to decide the mapping order.
DCI may also explicitly indicate the mapping order.

CB index order based on priority/logical channel index (such that URLLC CBs are always mapped from a first symbol).

As described above, for the standard transport processing procedure, for each transport block, the coded bits of multiple coded blocks will be modulated and mapped to resources in time, frequency and space domain, including different MIMO layers, and different time and frequency resources for transmission.

The space domain resources may include one or multiple MIMO layers, which are data streams that are precoded and transmitted in different transmit antennas.

The time and frequency resources may include different resource elements. For example, in NR, data can be transmitted in different symbols and different subcarriers, where the time and frequency grid of one symbol and one subcarrier is a resource element (RE). The modulated symbols of each transport block can map to the time frequency and space resource following a certain order. For example, the current NR maps the modulated symbols on different MIMO layers first and then frequency domain, and finally in time domain. With this order, the modulated symbols are first allocated into different MIMO transmission layers in order, with every n-th symbol being mapped to the n-th layer, and an L+1 symbol being mapped to a 1^{st} layer (assume there is total of L layers). After mapping to each transmission layer, the modulated symbols then go through a precoding process to produce modulated symbols to be transmitted on each antenna port. The modulated symbols to be transmitted on each antenna port then go through time-frequency resource mapping by mapping the modulated symbols onto different resource elements of the set of resource blocks scheduled by a base station. For example, when the resource mapping order is frequency first and time second (after MIMO layer mapping), then the block of modulated symbols in sequence will map to the REs (k, l)_{p,μ} allocated to the data transmission in increasing order of first the index k over the assigned resource blocks, and then the index l, where k is the subcarrier index in frequency domain, l is symbol index in time domain, and k=o is the first subcarrier in the first resource block assigned for the transmission.

In this example,
REs refers to resource elements,
the index l is over the assigned symbols, with l=o being the first symbol assigned for the transmission,
p is the index for the MIMO layer (or antenna port),
μ refers to a specific subcarrier spacing configuration (that is, a specific numerology).

In another example, when the resource mapping order is MIMO layer first, time second and frequency third, then the modulated symbol is first allocated to different MIMO layers as described above. Then the block of modulated symbols assigned to each layer in sequence will map to the REs (k, l)_{p,μ} allocated to the data transmission in increasing order of first the index 1 over the assigned symbols, then index k over assigned resource blocks.

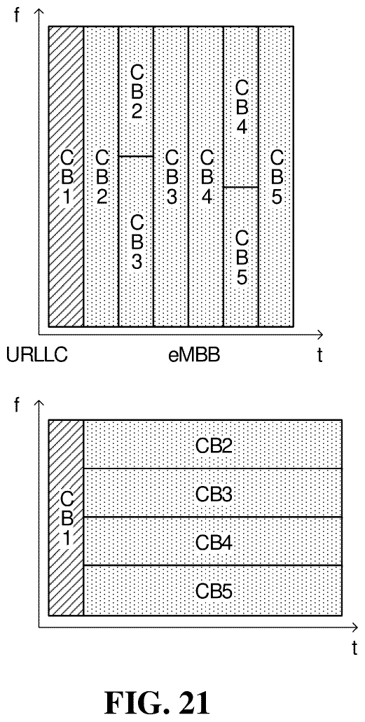

For mixed traffic coding, the resource mapping in time, frequency and MIMO layer domain can be traffic dependent or traffic aware. As URLLC requires lowest delay and highest reliability, the CB or CBs for URLLC should be mapped to the earliest resources as well as the most reliable resources. If the mapping order for the resource is MIMO layer first, frequency second followed by time domain, then to map URLLC resource in the earliest resource, URLLC CB can be placed in the beginning of a code bit stream when doing code block segmentation. That is, the CB or CBs for URLLC traffic should be assigned to the smallest CB indices. An example of such a mapping result is shown in the top of FIG. 21. Therefore, when different traffic types are transmitted in the same transport block, the order of index of CBs is traffic dependent, and the traffic with highest priority (URLLC for example) should have smallest CB index and be placed in the start of a code stream for code block concatenation, while the traffic with lower priority (such as eMBB) should have larger CB index.

Note that in the example of the top part of FIG. 21, the CB size of CB1, which corresponding to URLLC, is smaller than the CB size of the eMBB CBs (CB2-CB5), and thus it is mapped to only a single symbol while the eMBB CBs are mapped to one and a half symbols. The CB index may determine the order of the CBs being mapped to the time frequency resources, for example small CB index is mapped first.

The CB index ordering can be based on priority index indicated in DCI or priority information of logical channel index or other information that indicates the priority of the traffic. One advantage of the above scheme is that there is no need to define a new way or rule of mapping to resources each time, but just to define the orders of CB indices based on traffic type.

Another idea of traffic aware resource mapping is the resource mapping order in different dimensions may be traffic dependent. This may best help achieve different QoS requirements of different traffic. For example, for URLLC traffic, the mapping order can be MIMO layer first, then frequency, then time. This can allow CB of URLLC to occupy a limited number of early symbols, which allows fast decoding after receiving those symbols, which can help minimize delay. For eMBB traffic, the resource mapping order may be set to be MIMO layer first, time second and frequency third, to maximize or at least increase time diversity.

An example of such a mapping result is shown at the bottom in FIG. 21. In the context of this example, reference is made above to minimizing delay and maximizing time diversity. Delay may be at least reduced, and need not strictly be minimized. Similarly, time diversity may be at least increased, and need not strictly be maximized.

The association of the resource mapping order with traffic type may be predefined or configured in RRC. A UE can use the priority indication in DCI to decide the corresponding mapping order. A UE can also use priority information from other places to determine the corresponding mapping order, such as priority information in a logical channel, priority definition from 5G QoS in higher layer, and so on. In some other scenarios, DCI may explicitly indicate the mapping order for the whole transmission or for the specific traffic type of the transmission.

The traffic aware resource mapping can be applied for transmission of multiple traffic types when mixed traffic coding is used as described in this disclosure. It can also be applied to general transmissions when mixed traffic coding is not used. For example, the mapping order may be dependent on traffic types (depending on the priority indication in DCI for example) even though only one traffic type is transmitted in the transmission scheduled by the DCI.

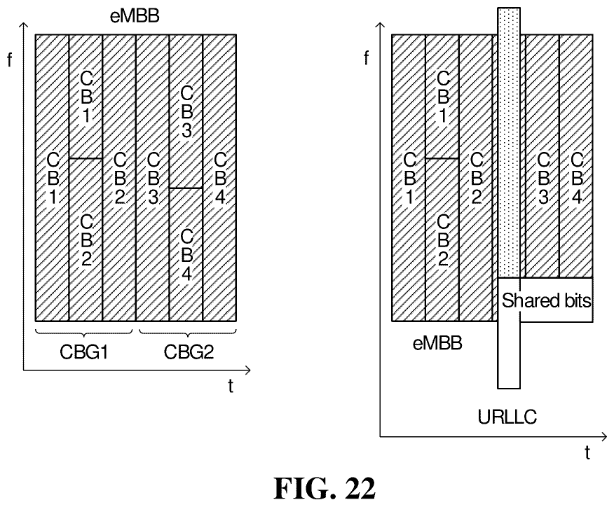

Some embodiments may involve pre-emption of one traffic type by a different traffic type. This may be referred to as multiplexing or conflict handling, for example. FIG. 22 illustrates an eMBB URLLC multiplexing scheme.

In the eMBB URLLC example shown in FIG. 22, eMBB traffic is pre-empted by URLLC traffic. This may also be referred to as an eMBB (traffic) transmission being pre-empted by a URLLC (traffic) transmission.

Examples of mixed traffic coding eMBB URLLC multiplexing may include: Mixed traffic coding is applied to the first CBG that is overlapped to the URLLC transmission.

Shared payload can be evenly distributed into different CBs of the eMBB CBG. Each CB is rate matched to non-overlapped resources.

If multiple eMBB CBs are not equal size after overlap of URLLC resources, the CB size needs to be re-distributed evenly.

These are examples of features that may be provided or supported for mixed traffic coding in conjunction with pre-emption. Any one or more of these features may be provided or supported. Although eMBB and URLLC are referenced in these examples, and elsewhere herein, these are also examples, and features disclosed herein may be applied to these and/or other types of traffic.

FIG. 22 shows an example of a mixed traffic coding scheme applied to eMBB URLLC multiplexing. The left figure shows the original scheduled eMBB transmission. The right figure shows that, when URLLC traffic arrives, the application of URLLC transmission as well as joint mixed traffic coding on the eMBB resources. In this scenario, a BS already scheduled eMBB transmission for a UE, and URLLC traffic arrives for the same UE (intra-UE) after the eMBB transmission is scheduled and before the eMBB transmission is finished. The UE then transmits the URLLC traffic at a resource that is at least partially overlapped with eMBB resources, and then performs joint mixed traffic coding on the remaining eMBB resources for the UE. This eMBB URLLC multiplexing transmission can be determined by the UE or scheduled by the base station.

In the example shown, the original scheduled eMBB transmission contains four CBs, with two CBGs each containing two CBs. This is an example only, and other CBG/CB arrangements are possible.

Note also that the above example of a UE transmitting URLLC and eMBB traffic is applicable to an uplink scenario, however the proposed scheme can be applied to downlink and/or sidelink scenarios as well. In a DL scenario, a BS or other network device is the device that transmits the eMBB and URLLC traffic as well as performs the encoding for mixed traffic coding, and a UE is the device that receives the transmissions and performs the corresponding decoding, but otherwise the same mechanism can be applicable to DL scenarios. Similarly, in a sidelink scenario a first UE transmits the eMBB and URLLC traffic and performs the encoding for mixed traffic coding, and a second UE receives the transmissions and performs the corresponding decoding, but otherwise the same mechanism can be applicable to sidelink scenarios.

One idea is that mixed traffic coding can be applied to the first CB or CBG that is overlapped with the URLLC transmission.

By applying mixed traffic coding, part or all of URLLC bits serve as shared bits, which are coupled with one or multiple CBs for joint encoding as described elsewhere herein.

When applied to the first CBG, the shared payload bits can be evenly distributed into different CBs of that eMBB CBG. Each CB is rate matched to the non-overlapped resources originally assigned for the CBG. If multiple eMBB CBs among the CBG are not equal sized in the remaining eMBB resource after URLLC occupies the overlapped resources, the CB size needs to redistributed evenly as shown at the right in FIG. 22.

In the example of FIG. 22, the URLLC is scheduled in the symbol after CB2, so the first CBG that is overlapped with URLLC is CBG2. The shared bits are evenly distributed to the two CBs, CB3 and CB4, in CBG2 in the example shown. An even distribution is shown in this example, and may be referenced in other examples, but shared bits could be distributed in other ways. The present disclosure is not limited to even distributions of shared bits.

Because URLLC resource is overlapping only with the original eMBB resources for CB3, the remaining resources for mixed traffic coding are redistributed among CBG2 such that the resources for CB3 and CB4 are almost equal.

Regarding receiver processing in a pre-emption scenario, pre-emption could be signaled, using a pre-emption indicator for example, to indicate to the receiver that one traffic type (eMBB in the example shown in FIG. 22) or one or more CB(s), for example, has been pre-empted by another traffic type (URLLC in the example shown in FIG. 22) or one or more other CB(s).

Although examples herein may refer to uplink transmission or might not specify transmission as uplink or downlink, it should be understood that features herein, such as coding and transmission schemes disclosed herein, may be adapted for transmission in downlink, uplink, or sidelink, or more generally for transmission between a transmitter and receiver. In downlink transmission, a BS or other network device is the transmitter and performs encoding and transmission operations, and a UE is the receiver and performs corresponding decoding operations. In uplink transmission, a UE is the transmitter and performs encoding and transmission operations, and a BS or other network device is the receiver and performs corresponding decoding operations. In sidelink transmission, both the transmitter and the receiver are UEs. One UE is the transmitter and performs encoding and transmission operations, and another UE is the receiver and performs corresponding decoding operations.

Other variations are also possible.

### Overview

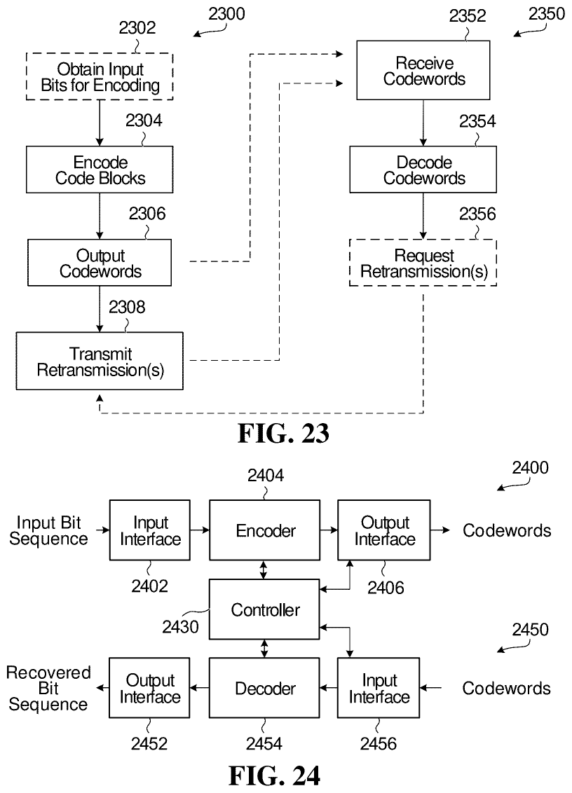

Various aspects of the present disclosure are described herein and shown in the drawings by way of example. FIG. 23 is a flow diagram illustrating more general example methods according to embodiments.

At the left, 2300 in FIG. 23 illustrates operations or features that may be provided or supported at an encoder or transmitter-side device, and at the right, 2350 illustrates operations or features that may be provided or supported at a decoder or receiver-side device. For ease of reference, in the following description of FIG. 23, a device at which encoding and/or transmitting features may be implemented or supported is called a first communication device, and a device at which decoding and/or receiving features may be implemented or supported is called a second communication device. Embodiments may involve either or both of such devices.

With reference first to 2300, the encoding at 2304 is intended to represent encoding a number of code blocks to generate codewords. The codewords include at least a first codeword that is generated by encoding a first code block of a first code block group and a second codeword generated by encoding a second code block of a second code block group. As disclosed herein, the first code block group is associated with a first traffic type (such as URLLC), and the second code block group is associated with a second traffic type different from the first traffic type (such as eMBB). URLLC and eMBB are examples of different traffic types with which code block groups may be associated.

The first code block includes information bits from only the first traffic type. This refers to a code block from which shared bits originate. For example, in some embodiments shared bits are copied from one CB (such as a URLLC CB) to one or more other CBs (such as eMBB CBs). Reference is made here to the first code block including information bits from only the first traffic type, so as to not preclude the first code block from potentially including other bits such as CRC bits. These other bits are not information bits from traffic that is to be encoded. A code block that is specific to a traffic type may include other bits, but its information bits include bits from only one traffic type.

The second code block referenced above includes information bits from the second traffic type and also includes bits that are associated with the first code block. These bits associated with the first code block may be, for example, information bits from the first code block (or in other words bits from traffic of the first traffic type) or transformed information bits. In an example that is provided above, a first message can be transformed (by multiplying with a binary matrix for example) and appended to a second message. This provides one example of transformed information bits, which are information bits multiplied with a binary matrix. In some embodiments, a method may include transforming information bits. A method may also or instead include combining the bits that are associated with the first code block with the information bits from the second traffic type, for example by appending the bits to or embedding the bits with the information bits from the second traffic type.

The second code block may include other bits, such as CRC bits, in addition to the information bits from the second traffic type and the bits that are associated with the first code block with the information bits.

The first codeword is decodable independently of the second codeword. This is referred to herein as self-decodability, and may also be described as a codeword being self-decodable or as one or more code blocks, individual payloads, or input bits being self-decodable from a codeword. The second codeword is also self-decodable, independently of the first codeword. More generally, each codeword is self-decodable.

In the example above, at least the first codeword is further decodable jointly with the second codeword. The second codeword may also be jointly decodable with the first codeword. More generally, one or more codewords may be jointly decodable with one or more other codewords between which there are shared bits, which are also referred to herein as common bits or coupling bits.

Self-decodability and joint decodability are described in further detail herein, with reference to FIGS. 6 and 8-12, for example.

There may be different maximum code block sizes for different traffic types. This is also referred to herein as traffic dependent maximum CB size Code block size. According to an example above, URLLC may have a smaller maximum CB size to allow for quick decoding, while eMBB may have larger maximum CB size, and maximum CB size can be configured and associated with priority index indication in DCI. Segmentation of information bits of a traffic into multiple CBs may be dependent upon the maximum CB size for the traffic type. For example if the number of information bits is below the maximum CB size then there may be a single CB for that traffic type, and otherwise (if the number of information bits for that traffic type is larger than the maximum CB size) the information bits for that traffic are segmented into multiple CBs. An example provided above refers to no further segmentation being needed at 1742 if the number of URLLC information bits is small, but the URLLC information bits being further segmented into multiple CBs (with each CB further having its own CRC added) if the number of URLLC information bits is large. A similar example is provided above for eMBB traffic, with combined eMBB data with shared URLLC bits being segmented into one or multiple CBs depending on the maximum CB size.

Thus, whether information bits are segmented into multiple CBs may depend on a maximum CB size. If the number of information bits (including shared bits in the case of traffic or data into which shared bits are embedded or otherwise combined) is larger than the maximum CB size, then segmentation into multiple CBs is performed. In the above example that includes first and second code blocks, a first size of the first code block is limited by a first maximum code block size and a second size of the second code block is limited by a second maximum code block size different from the first maximum code block size. More generally, a size of a code block for any traffic type may be limited by a maximum code block size for that traffic type. Another way to describe maximum code block sizes and their effect is that a code block for a traffic type has a size based on a maximum code block size for that traffic type. In the example above, the first code block may have a first size based on a first maximum code block size and the second code block may have has a second size based on a second maximum code block size different from the first maximum code block size. Code block size may be different depending on whether the information bits for a traffic type are included in a single CB, or are segmented into multiple CBs.

Some embodiments may provide or support CBG-based retransmission. CBs may be grouped, evenly or otherwise, into multiple CBGs. Retransmission after a decoding failure may then be CBG-based, such that retransmissions may be made only for CBGs for which there is a decoding failure. Therefore, some embodiments may involve transmitting, in response to a decoding failure a code block group, a retransmission for that code block group. This is illustrated at 2308 in FIG. 23. In the context of the example above with first and second code block groups, such transmitting may be in response to a decoding failure for one of the first code block group or the second code block group, and the retransmission is a retransmission for that one of the first code block group or the second code block group (that is affected or impacted by the decoding failure).

Retransmissions may, but need not necessarily, involve feedback. A receiving device may transmit, and a transmitting device may receive, feedback indicating a decoding failure for a code block group. Then the transmitting device may transmit a retransmission in response to receiving the feedback indicating the decoding failure, and the receiving device receives the retransmission. The retransmission in this example is for the code block group for which the received feedback indicates the decoding failure.

It should be noted, however, that not all embodiments necessarily involve feedback such as CBG based HARQ feedback. For example, for UL transmission, a network device such as a BS is the receiver and is also responsible for scheduling retransmission. In this scenario the receiver may not necessarily need to send feedback to the transmitter. Therefore, transmitting a retransmission is in response to a decoding failure, and may (but need not necessarily) be in response to receiving feedback indicating a decoding failure.

An example of such optional feedback, in the form of a retransmission request, is illustrated using a dashed line between 2356 and 2308 in FIG. 23.

A code block group may include one CB, or more than one CB. Information bits may be segmented into multiple CBs depending on the number of information bits for each traffic type and a respective maximum CB size for each traffic type, for example. Thus, some embodiments may involve segmenting information bits for a traffic type into multiple code blocks. This may be part of the encoding at 2304, or may be performed before encoding, at 2302 where input bits for encoding are obtained and may be pre-processed before encoding.

In some embodiments, a code block group that includes shared bits, such as the second code block group in an example above, includes multiple code blocks. Encoding at 2304 may then involve encoding the multiple code block to generate multiple codewords. In the context of the second code block group in the example above, the encoding may involve encoding the multiple second code blocks to generate multiple second codewords.

Further in this context, each second code block may include bits that are associated with the first code block (also referred to herein as shared bits, for example), and those shared bits may be distributed among the of second code blocks. The first codeword is decodable independently of the multiple second codewords, and is further decodable jointly with the multiple second codewords. More generally, multiple code blocks for one traffic type may include shared bits associated with another code block and be encoded to generate multiple codewords, the shared bits may be distributed among those code blocks, and a codeword that is generated by encoding the other code block may be decodable independently of the multiple codewords and further decodable jointly with the multiple codewords.

Several shared bit distribution options are described herein.

For example, the shared bits may be distributed evenly among code blocks. In the context of the above example with the second code block group including multiple second code blocks, the bits that are associated with the first code block may be distributed evenly among the second code blocks. This is described above at least with reference to FIGS. 18 and 19.

Shared bits need not necessarily be evenly distributed. In some embodiments, shared bits are repeated in multiple code blocks, such that each code block that includes shared bits includes the same shared bits. In the above example with first and second code blocks, the bits that are associated with the first code block and are distributed among the second code blocks may be the same in each second code block.

Another possible option involves more limited distribution of shared bits, to couple code block groups rather than all code blocks. For example, only a subset of code blocks in a code block group might include shared bits. Such a limited distribution of shared bits still supports joint decoding. The subset of code blocks may include, for example, only a first code block or only one or more code blocks in a first code block group.

With reference again to the example above, with first and second code block groups, according to a limited shared bit distribution embodiment only a subset of the second code blocks include bits that are associated with the first code block. The first codeword is decodable independently of the second codewords, and is further decodable jointly with the second codewords that are generated by encoding the second code blocks of the subset. The second code blocks of the subset are the second code blocks that include the shared bits associated with the first code block.

Any or all of the code block groups may include multiple CBs. In the above example that includes first and second code block groups, the first code block group may also or instead include multiple first code blocks, in which case the encoding at 2304 involves encoding the multiple first code blocks to generate multiple first codewords. Segmenting into multiple first code blocks may be performed at 2302 in pre-processing information bits before encoding, or may be part of an encoding process.

A coupled code block group may include one or more coupled code blocks into which shared bits are combined. Codewords that are generated by encoding source code blocks (with which shared bits are associated) are self-decodable independently of the coupled codeword(s) generated by encoding the coupled code block(s) and are also jointly decodable with coupled codeword(s). In the example above with first and second code block groups, if the first code block group includes multiple first code blocks and the second code block includes bits associated with the multiple first code blocks, then the multiple first codewords (generated by encoding the multiple first code blocks) are decodable independently of the second codeword and are further decodable jointly with the second codeword.

Embodiments in which multiple code block groups each include multiple code blocks are also possible. In the context of the example above, the first code block group includes multiple first code blocks, the encoding involves encoding the multiple first code blocks to generate multiple first codewords, the second code block group includes multiple second code blocks, and the encoding also involves encoding the multiple second code blocks to generate multiple second codewords.

In such embodiments, coupled code blocks include shared bits from other code blocks, and codewords generated by encoding the other code blocks are decodable independently of coupled codewords generated by encoding the coupled code blocks and are further decodable jointly with the coupled codewords. In the context of the above example with a first code block group that includes multiple first code blocks and a second code block group that includes multiple second code blocks, the second code blocks include bits associated with the first code blocks, and the first codewords and the second codewords (generated by encoding the first code blocks and the second code blocks, respectively), include codewords that are decodable independently of each other and are further decodable jointly with each other. It should be noted, however, that in multi-CB embodiments in which CBGs associated with respective different traffic types include multiple CBs, not every codeword is necessarily jointly decodable. In some embodiments there may be other codewords, CBs, and/or CBGs that are self-decodable but are not jointly decodable.

Any of several shared bit distribution options, including the examples above, may be applied to embodiments in which CBGs that are associated with respective different traffic types include multiple CBs. For example, the shared bits from CBs for one traffic type that are combined into CBs for another traffic type may be consistent with an even distribution from among the CBs for that one traffic type. In other words, the shared bits from each CB for the one traffic type may be evenly distributed among the CBs for the other traffic type. The shared bits may be repeated in each of the CBs for the other traffic type, or combined into only a subset of those CBs, such as only the first CB or one or more CBs in a first CBG for the other traffic type.

In the context of the above example with a first code block group and a second code block group, in an even distribution embodiment the bits associated with the multiple first code blocks (which are included in the second code blocks) are consistent with an even distribution from among the multiple first code blocks. In other embodiments the bits associated with the multiple first code blocks are repeated in the second code blocks, in which case the second code blocks each include the bits associated with the multiple first code blocks. For a more limited distribution, only a subset of the second code blocks include bits associated with the multiple first code blocks.

Shared bits may be positioned in a coupled code block according to any of various conditions or rules, including positioning based on reliabilities for example. The following options relate to reliability-based positioning in the context of CBGs that include one, or more than one, CB:
shared bits associated with a code block of a code block group associated with one traffic type may be positioned in a code block of a code block group associated with another traffic type based on reliabilities of bit positions in the latter code block (of the latter code block group associated with the other traffic type)—in the context of the example above with a first code block group that includes a first code block and a second code block group that includes a second code block, the bits associated with the first code block may be positioned in the second code block based on reliabilities of bit positions in the second code block;
shared bits associated with a code block of a code block group associated with one traffic type may be distributed among and positioned in multiple code blocks of a code block group associated with another traffic type based on reliabilities of bit positions in the latter code blocks (of the latter code block group associated with the other traffic type)—in the context of the example above with a first code block group that includes a first code block and a second code block group that includes multiple second code blocks, the bits that are associated with the first code block and are distributed among the multiple second code blocks are positioned in the multiple second code blocks based on reliabilities of bit positions in the second code blocks;
shared bits associated with multiple code blocks of a code block group associated with one traffic type may be distributed among and positioned in a code block of a code block group associated with another traffic type based on reliabilities of bit positions in the latter code block (of the latter code block group associated with the other traffic type)—in the context of the example above with a first code block group that includes multiple first code blocks and a second code block group that includes a second code block, the bits associated with the multiple first code blocks are positioned in the second code block based on reliabilities of bit positions in the second code block;
shared bits associated with multiple code blocks of a code block group associated with one traffic type may be distributed among and positioned in multiple code blocks of a code block group associated with another traffic type based on reliabilities of bit positions in the latter code blocks (of the latter code block group associated with the other traffic type)—in the context of the example above with a first code block group that includes multiple first code blocks and a second code block group that includes multiple second code blocks, the bits associated with the multiple first code blocks are positioned in the multiple second code blocks based on reliabilities of bit positions in the plurality of second code blocks.

FIG. 23 illustrates outputting codewords at 2306, and the codewords may be transmitted as illustrated by the dashed line from 2306 to 2352. Such transmitting may involve using respective communication resources that are mapped based on traffic types, which is also referred to herein as traffic dependent resource mapping or resource mapping order. In the context of the above example of a first code block group and a second code block group, transmitting the first codeword and the second codeword using respective communication resources that are mapped based on the first traffic type and the second traffic type.

Resource mapping based on traffic type may include any one or more of the following, for example:
mapping a traffic type (URLLC traffic for example) to frequency (subcarrier) and/or spatial (layer) resources that have better channel quality, and/or to time slots that are transmitted earlier, to help ensure reliable and low-latency reception of a certain traffic type;
traffic dependent resource mapping order, to satisfy QoS requirements or targets for example—such as MIMO layers-frequency-time order for a traffic type (URLLC for example) to minimize or at least lower or reduce decoding delay; MIMO layers-time-frequency order for a traffic type (eMBB for example) to maximize or at least increase time diversity;
CB index order, based on either or both of priority or logical channel index for example, according to which CBs for a traffic type (such as URLLC CBs) are always mapped from a first symbol);
more generally, resource mapping in time, frequency and MIMO layer domain (which may also be referred to as resource mapping order) may be traffic dependent or traffic aware, based on traffic type.

Some embodiments may involve pre-emption of one traffic type by a different traffic type. This is shown by way of example in FIG. 22, in which eMBB traffic is pre-empted by URLLC traffic. In the context of an example above with a first code block group and a second code block group, the second code block group may include a subsequent code block group that is associated with the second traffic type (CBG2 for eMBB in FIG. 22), is subsequent to a preceding code block group associated with the second traffic type (CBG1 for eMBB in FIG. 22), and is subsequent to pre-emption of the second type of traffic by the first type of traffic (URLLC in FIG. 22) from which the first code block includes information bits.

The example in FIG. 22 is illustrative of an embodiment in which mixed traffic coding is applied to the first CB (CB3) or CBG (CBG2) that is overlapped with by the pre-emption. In the context of the first/second code block group example above, the “first CB that is overlapped” (CB3) is the above-referenced second CB, which includes shared bits associated with the URLLC CB. FIG. 22 is also illustrative of shared bits (associated with a first traffic type) being evenly distributed into different CBs of the second CBG (the eMBB CBG2 in FIG. 22). Some embodiments may involve rate matching each CB to the non-overlapped resources originally assigned for the CBG, shown at the right in FIG. 22 for CB3 and CB4. FIG. 22 further illustrates that if multiple CBs among the CBG to which mixed coding is applied are not equal sized in the remaining resources after the overlapped resources, the CB size is redistributed evenly. Such redistribution of CB size, which may also be described as resizing CBs or changing CB size for example, is evident from different sizes for CB3 and CB4 between the left and right diagrams in FIG. 22.

Embodiments consistent with the present disclosure may provide or support other features, and several examples are included in FIG. 23. In some embodiments codewords generated by the encoding at 2304 may be output by an encoder at 2306 for further processing or handling, and may be transmitted as shown by the dashed line from 2306 to 2352. The codewords may be output to memory, for example.

Similarly, obtaining input bits for encoding, as shown at 2302 in FIG. 22, may be performed or supported separately from encoding at 2304 and/or outputting at 2306. The input bits for encoding may be or include data from different devices and/or data associated with different services, for example. Obtaining the input bits at 2302 may involve, for example any of various operations, such as any one or more of the following: collecting or otherwise receiving data outputs from one or more devices and/or services; accessing data in a memory; segmenting or otherwise pre-processing data before encoding.

Another example of features that may be provided in some embodiments but are not explicitly shown in FIG. 23 relates to signaling. Some embodiments may involve transmitting and/or receiving signaling or any of various types of indications. More generally, embodiments may involve communicating, in a wireless communication network, signaling indicative of any of various parameters. Parameters related to one or more of segmentation, encoding, transmission, reception, or decoding may be indicated in signaling.

Such communicating of signaling may involve transmitting the signaling by an encoder/encoding device or a transmitter/transmitting device that is to transmit codewords, to a decoder/decoding device or a receiver/receiving device. The communicating may also or instead involve receiving the signaling by a decoder/decoding device or a receiver/receiving device from an encoder/encoding device or a transmitter/transmitting device. Signaling need not necessarily be between, or only between, communication devices by which encoded blocks are to be transmitted or received. For example, a network device such as a gNB or a base station may transmit signaling to configure parameters at one or more communication devices. Therefore, a method may involve a network device transmitting signaling, and an encoder/encoding device or a transmitter/transmitting device receiving the signaling from the network device, and/or a decoder/decoding device or a receiver/receiving device receiving the signaling from the network device.

At 2350, FIG. 23 illustrates various decoding and/or receiving counterparts of the features shown at 2300. From a receiving device perspective, the receiving at 2352 is intended to represent receiving codewords, such as the first and second codewords referenced above. Codewords received at 2352 may be received in an initial transmission or a retransmission.

In an embodiment, a method involves receiving, at 2352, codewords generated by encoding code blocks. As in an example described in detail above, the codewords may include a first codeword generated by encoding a first code block of a first code block group that is associated with a first traffic type, and a second codeword generated by encoding a second code block of a second code block group that is associated with a second traffic type different from the first traffic type. The first code block includes information bits from only the first traffic type, and the second code block includes information bits from the second traffic type and bits associated with the first code block.

Such a method may also involve decoding the first codeword and the second codeword, at 2354. The first codeword is decodable independently of the second codeword, and is decodable jointly with the second codeword. The second codeword is similarly decodable independently of the first codeword, and is decodable jointly with the first codeword.

FIG. 23 also illustrates an optional feature of requesting one or more retransmissions, at 2356. This may involve, for example, transmitting a retransmission request or an indication of a decoding failure for a code block group. As described in detail elsewhere herein, there may be multiple decoding attempts at 2354 (to self-decode and jointly decode) before a retransmission is requested, or more generally before a retransmission.

Embodiments related to receiving and/or decoding may include other features, such as any one or more of the following features, for example, which are also discussed elsewhere herein:
there may be different maximum CB sizes based on traffic type;
a first size of the first code block may be limited by a first maximum code block size and a second size of the second code block may be limited by a second maximum code block size different from the first maximum code block size;
CBG-based retransmission, using HARQ in some embodiments, may be provided or supported;
a method may involve receiving, in response to a decoding failure for one of the first code block group or the second code block group, a retransmission for the one of the first code block group or the second code block group;
a method may involve transmitting, in response to a decoding failure for one of the first code block group or the second code block group, feedback indicating the decoding failure;
in an embodiment in which such feedback is transmitted, a method may involve receiving, in response to the feedback, a retransmission for the one of the first code block group or the second code block group for which the feedback indicates the decoding failure;
there may be multiple CBs (for eMBB for example) for joint coding;
for example, the second code block group may include second code blocks, in which case the receiving may involve receiving multiple second codewords that were generated by encoding the second code blocks;
each of multiple code blocks may include shared bits;
for example, each second code block may include bits that are associated with the first code block and are distributed among the second code blocks, in which case the first codeword is decodable independently of the second codewords and is further decodable jointly with the second codewords;
shared bits may be evenly distributed;
for example, the bits that are associated with the first code block may be distributed evenly among the second code blocks;
shared bits may be repeated;
for example, the bits that are associated with the first code block and are distributed among the second code blocks may be the same in each second code block;
distribution of shared bits may be limited;
for example, only a subset of the second code blocks might include bits that are associated with the first code block, in which case the first codeword is decodable independently of the second codewords and is further decodable jointly with the second codewords generated by encoding the second code blocks of the subset;
a CBG from which shared bits originate may also or instead include multiple CBs;
for example, the first code block group may include multiple first code blocks, in which case the receiving involves receiving multiple first codewords generated by encoding the first code blocks, the second code block includes bits associated with the first code blocks, and the first codewords are decodable independently of the second codeword and further decodable jointly with the second codeword;
multiple CBGs may each include multiple CBS;
for example, the first code block group may include multiple first code blocks and the second code block group may include multiple second code blocks, in which case the receiving involves receiving multiple first codewords generated by encoding the multiple first code blocks and multiple second codewords generated by encoding the multiple second code blocks;
the second code blocks may include bits associated with the first code blocks, in which case the first codewords and the second codewords include codewords that are decodable independently of each other and are further decodable jointly with each other;
the bits associated with the first code blocks may be consistent with an even distribution from among the first code blocks;
other distributions are also possible, and examples are provided at least above;
positioning of shared bits may be based on reliability;
for example, the bits associated with the first code block may be positioned in the second code block based on reliabilities of bit positions in the second code block;
in one multi-CB embodiment, bits that are associated with the first code block and are distributed among multiple second code blocks may be positioned in the second code blocks based on reliabilities of bit positions in the second code blocks;
in another multi-CB embodiment, bits associated with multiple first code blocks may be positioned in the second code block based on reliabilities of bit positions in the second code block;
in a further multi-CB embodiment, bits associated with multiple first code blocks may be positioned in multiple second code blocks based on reliabilities of bit positions in the second code blocks;
traffic aware resource mapping may be provided or supported;
for example, a method may involve receiving the first codeword and the second codeword using respective communication resources that are mapped based on the first traffic type and the second traffic type;
features related to multiplexing or pre-emption as described herein may be provided or supported in some embodiments;
for example, the second code block group may be a subsequent code block group that is associated with the second traffic type, is subsequent to a preceding code block group associated with the second traffic type, and is subsequent to pre-emption of the second type of traffic by the first type of traffic from which the first code block comprises information bits.

A method related to receiving codewords and/or decoding codewords may also provide or support other features, such as receiving or decoding counterparts of features described herein in the context of methods related to encoding and/or transmitting codewords.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

An apparatus may include a processor that is configured, by executing programming for example, to cause the apparatus to perform a method or operations, or to provide or support features, disclosed herein. An apparatus may also include a non-transitory computer readable storage medium, coupled to the processor, storing programming for execution by the processor. In FIG. 3, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

As an illustrative example, programming stored in or on a non-transitory computer readable storage medium may include instructions to or to cause a processor to, or a processor, device, or other component may otherwise be configured to, encode code blocks to generate codewords, and to output the codewords. As in another example described at least above, the codewords include a first codeword generated by encoding a first code block of a first code block group that is associated with a first traffic type, and a second codeword generated by encoding a second code block of a second code block group that is associated with a second traffic type different from the first traffic type. The first code block includes information bits from only the first traffic type, and the second code block includes information bits from the second traffic type and bits associated with the first code block. The first codeword is decodable independently of the second codeword, and is further decodable jointly with the second codeword.

Apparatus embodiments are not limited to the foregoing examples, or to processor-based or programming-based embodiments. An apparatus may also or instead include, for example, an encoder for encoding code blocks to generate codewords, and an interface, coupled to the encoder, for outputting the codewords.

FIG. 24 is a block diagram illustrating an apparatus according to an embodiment. At 2400, FIG. 24 illustrates components of an example apparatus in which or in conjunction with which transmitting and/or encoding features may be implemented, and components of an example apparatus in which or in conjunction with which receiving and/or decoding features may be implemented are illustrated at 2450. A controller 2430 may be provided in either of these types of apparatus. In some embodiments, an apparatus may include both transmitting and receiving features, and either or both of encoding features or decoding features. In the example shown in FIG. 24, an apparatus with all of the illustrated components supports both encoding features and decoding features, as well and transmitting features and receiving features.

For encoding features and transmitting features, the example apparatus in FIG. 24 includes an input interface 2402, an encoder 2404 coupled to the input interface, an output interface 2406, and a controller 2430 coupled to the encoder and the transmitter. An input bit sequence for encoding is shown as an input to the input interface 2402, and codewords are shown as outputs from the output interface 2406. Although shown as a separate component in FIG. 24, the output interface 2406 for transmitting or otherwise outputting codewords may be provided by, incorporated into, or coupled to the encoder 2404. Similarly, although shown as a separate input interface 2402 in FIG. 24, an interface through which input bits for encoding are obtained by the encoder 2404 may be provided by, incorporated into, or coupled to the encoder.

Encode-side or transmit-side features or functions, and other features or functions herein, may be implemented in any of various ways, such as in hardware, firmware, or one or more components that execute software. The present disclosure is not limited to any specific type of implementation, and implementation details may vary between different devices.

Input bits may be obtained, and codewords may be transmitted or otherwise output, via any of various types of interface, including a communication interface in the case of transmitting codewords or receiving input bits for encoding. Embodiments are not in any way restricted to any particular type of interface, the implementation of which may be based at least in part on how input bits are to be obtained and how codewords are to be output.

In an embodiment, an apparatus includes an encoder such as the encoder 2404 for encoding a code blocks to generate codewords. An interface may be provided and coupled to an encoder, and in the example shown the output interface 2406 is coupled to the encoder 2404 for outputting the codewords. As in another example described at least above, the codewords include a first codeword generated by encoding a first code block of a first code block group that is associated with a first traffic type, and a second codeword generated by encoding a second code block of a second code block group that is associated with a second traffic type different from the first traffic type. The first code block includes information bits from only the first traffic type, and the second code block includes information bits from the second traffic type and bits associated with the first code block. The first codeword is decodable independently of the second codeword, and is further decodable jointly with the second codeword.

More generally, an apparatus or a component thereof such as an encoder 2404 or a processor may be configured to encode (or for encoding) code blocks to generate codewords. An apparatus or a component thereof such as an interface 2406, which may be coupled to the encoder 2404, may be configured to output (or for outputting), or programming may include instructions to output (or for outputting) or to cause a processor to output, the codewords as disclosed herein.

Embodiments related to such apparatus or non-transitory computer readable storage media may include any one or more of the following features, for example, which are also discussed elsewhere herein:
there may be different maximum CB sizes based on traffic type;
a first size of the first code block may be limited by a first maximum code block size and a second size of the second code block may be limited by a second maximum code block size different from the first maximum code block size;
CBG-based retransmission, using HARQ in some embodiments, may be provided or supported;
the apparatus or a component thereof such as the interface 2406 or a transmitter may be configured to transmit (or for transmitting), or programming may include instructions to transmit (or for transmitting), or to cause a processor to transmit, in response to a decoding failure for one of the first code block group or the second code block group, a retransmission for the one of the first code block group or the second code block group;
the apparatus or a component thereof such as the interface 2456 or a receiver may be configured to receive (or for receiving), or programming may include instructions to receive (or for receiving), or to cause a processor to receive feedback indicating the decoding failure;
in an embodiment that supports such feedback, the apparatus or a component thereof such as the interface 2406 or a transmitter may be configured to transmit (or for transmitting), or programming may include instructions to transmit (or for transmitting), or to cause a processor to transmit, in response to the feedback, a retransmission for the one of the first code block group or the second code block group for which the feedback indicates the decoding failure;
there may be multiple CBs (for eMBB for example) for joint coding;
for example, the second code block group may include second code blocks—the apparatus or a component thereof such as the encoder 2404 may be configured to encode (or for encoding), or programming may include instructions to encode (or for encoding), or to cause a processor to encode the second code blocks to generate multiple second codewords;
each of multiple code blocks may include shared bits;
for example, each second code block may include bits that are associated with the first code block and are distributed among the second code blocks, in which case the first codeword is decodable independently of the second codewords and is further decodable jointly with the second codewords;
shared bits may be evenly distributed;
for example, the bits that are associated with the first code block may be distributed evenly among the second code blocks;
shared bits may be repeated;
for example, the bits that are associated with the first code block and are distributed among the second code blocks may be the same in each second code block;
distribution of shared bits may be limited;
for example, only a subset of the second code blocks might include bits that are associated with the first code block, in which case the first codeword is decodable independently of the second codewords and is further decodable jointly with the second codewords generated by encoding the second code blocks of the subset;
a CBG from which shared bits originate may also or instead include multiple CBS;
for example, the first code block group may include multiple first code blocks, in which case there are multiple first codewords generated by encoding the first code blocks, the second code block includes bits associated with the first code blocks, and the first codewords are decodable independently of the second codeword and further decodable jointly with the second codeword—the apparatus or a component thereof such as the encoder 2404 may be configured to encode (or for encoding), or programming may include instructions to encode (or for encoding), or to cause a processor to encode the first code blocks to generate the multiple first codewords;
multiple CBGs may each include multiple CBs;
for example, the first code block group may include multiple first code blocks and the second code block group may include multiple second code blocks—the apparatus or a component thereof such as the encoder 2404 may be configured to encode (or for encoding), or programming may include instructions to encode (or for encoding), or to cause a processor to encode multiple first code blocks to generate multiple first codewords and encode multiple second code blocks to generate multiple second codewords;
the second code blocks may include bits associated with the first code blocks, in which case the first codewords and the second codewords include codewords that are decodable independently of each other and are further decodable jointly with each other;
the bits associated with the first code blocks may be consistent with an even distribution from among the first code blocks;
other distributions are also possible, and examples are provided at least above;
positioning of shared bits may be based on reliability;
for example, the bits associated with the first code block may be positioned in the second code block based on reliabilities of bit positions in the second code block;
in one multi-CB embodiment, bits that are associated with the first code block and are distributed among multiple second code blocks may be positioned in the second code blocks based on reliabilities of bit positions in the second code blocks;
in another multi-CB embodiment, bits associated with multiple first code blocks may be positioned in the second code block based on reliabilities of bit positions in the second code block;
in a further multi-CB embodiment, bits associated with multiple first code blocks may be positioned in multiple second code blocks based on reliabilities of bit positions in the second code blocks;
traffic aware resource mapping may be provided or supported;
for example, the apparatus or a component thereof such as the interface 2406 or a transmitter may be configured to transmit (or for transmitting), or programming may include instructions to transmit (or for transmitting), or to cause a processor to transmit the first codeword and the second codeword using respective communication resources that are mapped based on the first traffic type and the second traffic type;
features related to multiplexing or pre-emption as described herein may be provided or supported in some embodiments;
for example, the second code block group may be a subsequent code block group that is associated with the second traffic type, is subsequent to a preceding code block group associated with the second traffic type, and is subsequent to pre-emption of the second type of traffic by the first type of traffic from which the first code block comprises information bits.

With reference again to FIG. 24, the example apparatus also includes components to provide or support receiving and decoding features. These components may be provided separately in a decoding or receiving device, or together with other components to provide or support decoding or receiving features together with encoding or transmitting features.

An input interface 2456 is coupled to a decoder 2454, and these components are also coupled to the controller 2430. The decoder 2454 is coupled to an output interface 2452. A recovered bit sequence is shown as an output from the output interface 2452, and codewords are shown as inputs received by the interface 2456. The interface 2456 may be provided by, incorporated into, or coupled to the decoder 2454, and similarly an interface through which a recovered bit sequence is output by the decoder may be provided by, incorporated into, or coupled to the decoder. Decode-side or receive-side features or functions, and other features or functions herein, may be implemented in any of various ways, such as in hardware, firmware, or one or more components that execute software. The present disclosure is not limited to any specific type of implementation, and implementation details may vary between different devices, for example.

Codewords may be received or otherwise obtained, and a recovered bit sequence may be output, via any of various types of interface, including a communication interface in the case of receiving encoded bits or transmitting a recovered bit sequence. Embodiments are not in any way restricted to any particular type of receiver or interface, the implementation of which may be based at least in part on how codewords for decoding are to be obtained and how a recovered bit sequence is to be output. Encoder and decoder interfaces are shown separately in FIG. 24 to illustrate that encoding and decoding features may be implemented independently. However, it should be appreciated that a single device or equipment may support both encoding and decoding, in which case an encoder and a decoder may be coupled to the same interface(s) at 2402, 2452. For example, the encoder 2404 and the decoder 2454 may be coupled to the same interface(s) to obtain a bit sequence for encoding by the encoder and to output bit sequences recovered by the decoder. The encoder 2404 and the decoder 2454 may also or instead be coupled to the same interface(s) to output codewords that are generated by the encoder and receive codewords for decoding by the decoder.

In an embodiment, an apparatus includes a decoder such as the decoder 2454 for decoding received codewords. The interface 2456 is coupled to the decoder, for receiving the codewords as disclosed herein. An apparatus may also include an interface such as the output interface 2452 in some embodiments, for outputting recovered bit sequences. More generally, an apparatus or a component thereof such as a decoder 2454 or a processor may be configured to decode (or for decoding) codewords, or programming may include instructions to decode (or for decoding) codewords. An apparatus or a component thereof such as an interface 2456 coupled to the decoder 2454, may be configured to receive (or for receiving) or to otherwise obtain (or for obtaining), or programming may include instructions to receive (or for receiving) or to otherwise obtain (or for obtaining) or to cause a processor to receive or otherwise obtain, the codewords. Receiving may involve receiving the codewords from a first communication device by a second communication device in a wireless communication network for example.

As in an example described in further detail at least above, the codewords include a first codeword generated by encoding a first code block of a first code block group that is associated with a first traffic type, and a second codeword generated by encoding a second code block of a second code block group that is associated with a second traffic type different from the first traffic type. The first code block includes information bits from only the first traffic type, and the second code block includes information bits from the second traffic type and bits associated with the first code block. The decoding involves decoding the first codeword and the second codeword to obtain the first code block and the second code block, and the first codeword is decodable independently of the second codeword and further decodable jointly with the second codeword.

Embodiments related to such apparatus or non-transitory computer readable storage media may include any one or more of the following features, for example, which are also discussed elsewhere herein:
there may be different maximum CB sizes based on traffic type;
a first size of the first code block may be limited by a first maximum code block size and a second size of the second code block may be limited by a second maximum code block size different from the first maximum code block size;
CBG-based retransmission, using HARQ in some embodiments, may be provided or supported;
the apparatus or a component thereof such as the interface 2456 or a receiver may be configured to receive (or for receiving), or programming may include instructions to receive (or for receiving), or to cause a processor to receive, in response to a decoding failure for one of the first code block group or the second code block group, a retransmission for the one of the first code block group or the second code block group;
the apparatus or a component thereof such as the interface 2406 or a transmitter may be configured to transmit (or for transmitting), or programming may include instructions to transmit (or for transmitting), or to cause a processor to transmit feedback indicating the decoding failure;
in an embodiment that supports such feedback, the apparatus or a component thereof such as the interface 2456 or a receiver may be configured to receive (or for receiving), or programming may include instructions to receive (or for receiving), or to cause a processor to receive, in response to the feedback, a retransmission for the one of the first code block group or the second code block group for which the feedback indicates the decoding failure;
there may be multiple CBs (for eMBB for example) for joint coding;
for example, the second code block group may include second code blocks—the apparatus or a component thereof such as the interface 2456 or a receiver may be configured to receive (or for receiving), or programming may include instructions to receive (or for receiving), or to cause a processor to receive the second codewords that are generated by encoding the multiple second code blocks;
each of multiple code blocks may include shared bits;
for example, each second code block may include bits that are associated with the first code block and are distributed among the second code blocks, in which case the first codeword is decodable independently of the second codewords and is further decodable jointly with the second codewords;
shared bits may be evenly distributed;
for example, the bits that are associated with the first code block may be distributed evenly among the second code blocks;
shared bits may be repeated;
for example, the bits that are associated with the first code block and are distributed among the second code blocks may be the same in each second code block;
distribution of shared bits may be limited;
for example, only a subset of the second code blocks might include bits that are associated with the first code block, in which case the first codeword is decodable independently of the second codewords and is further decodable jointly with the second codewords generated by encoding the second code blocks of the subset;
a CBG from which shared bits originate may also or instead include multiple CBs;
for example, the first code block group may include multiple first code blocks, in which case there are multiple first codewords generated by encoding the first code blocks, the second code block includes bits associated with the first code blocks, and the first codewords are decodable independently of the second codeword and further decodable jointly with the second codeword—the apparatus or a component thereof such as the interface 2456 or a receiver may be configured to receive (or for receiving), or programming may include instructions to receive (or for receiving), or to cause a processor to receive the first codewords that are generated by encoding the multiple first code blocks;
multiple CBGs may each include multiple CBs;
for example, the first code block group may include multiple first code blocks and the second code block group may include multiple second code blocks—the apparatus or a component thereof such as the interface 2456 or a receiver may be configured to receive (or for receiving), or programming may include instructions to receive (or for receiving), or to cause a processor to receive multiple first codewords generated by encoding the multiple first code blocks and multiple second codewords generated by encoding the multiple second code blocks;
the second code blocks may include bits associated with the first code blocks, in which case the first codewords and the second codewords include codewords that are decodable independently of each other and are further decodable jointly with each other;
the bits associated with the first code blocks may be consistent with an even distribution from among the first code blocks;
other distributions are also possible, and examples are provided at least above;
positioning of shared bits may be based on reliability;
for example, the bits associated with the first code block may be positioned in the second code block based on reliabilities of bit positions in the second code block;
in one multi-CB embodiment, bits that are associated with the first code block and are distributed among multiple second code blocks may be positioned in the second code blocks based on reliabilities of bit positions in the second code blocks;
in another multi-CB embodiment, bits associated with multiple first code blocks may be positioned in the second code block based on reliabilities of bit positions in the second code block;
in a further multi-CB embodiment, bits associated with multiple first code blocks may be positioned in multiple second code blocks based on reliabilities of bit positions in the second code blocks;
traffic aware resource mapping may be provided or supported;
for example, the apparatus or a component thereof such as the interface 2456 or a receiver may be configured to receive (or for receiving), or programming may include instructions to receive (or for receiving), or to cause a processor to receive the first codeword and the second codeword using respective communication resources that are mapped based on the first traffic type and the second traffic type;
features related to multiplexing or pre-emption as described herein may be provided or supported in some embodiments;
for example, the second code block group may be a subsequent code block group that is associated with the second traffic type, is subsequent to a preceding code block group associated with the second traffic type, and is subsequent to pre-emption of the second type of traffic by the first type of traffic from which the first code block comprises information bits.

Other features disclosed herein may also or instead be provided or supported in apparatus embodiments.

Apparatus embodiments are not in any way restricted to single devices. A system, for example, may include a first communication device and a second communication device. The first communication device may be configured to encode multiple code blocks to generate codewords including a first codeword and a second codeword, and to transmit the codewords. The second communication device may be configured to receive and decode the first codeword and the second codeword. The first codeword is generated by encoding a first code block of a first code block group that is associated with a first traffic type and the second codeword is generated by encoding a second code block of a second code block group that is associated with a second traffic type different from the first traffic type. The first code block includes information bits from only the first traffic type, and the second code block includes information bits from the second traffic type and bits associated with the first code block. The first codeword is decodable independently of the second codeword, and is further decodable jointly with the second codeword.

More generally, other features disclosed herein may also or instead be provided in method, apparatus, and/or system embodiments.

Example embodiments disclosed herein may include the following benefits or features:

Traffic aware CB segmentation and CBG mapping:
Allows each traffic to have to its own HARQ feedback through CBG mapping, without additional signaling.
No additional signaling is required, for example, for feedback that is specific to traffic type.

Evenly distributes shared payload mapping on different CBs:
Distributed CB mapping of shared payload may help improve coupling efficiency and overall decoding performance.
Overall decoding performance may also be improved.
Distribution may be even among different CBs, but need not necessarily be even in all embodiments.

Traffic aware resource mapping; Traffic specific resource mapping order; Priority dependent CB ordering:
Priority based CB ordering allows URLLC to transmit first, without additional mechanism/signaling on resource mapping.
More generally, priority based CB ordering may allow higher priority traffic to be transmitted first, without an additional mechanism or signaling on resource mapping. URLLC traffic is an example of higher priority traffic.
Traffic dependent resource mapping order provides a more customized resource mapping solution that matches QoS requirements.

The following acronyms, abbreviations, and initialisms may be used herein:

| Full Name | Acronym/Abbreviation/Initialism |
|---|---|
| Acknowledgement | ACK |
| Non-Acknowledgement | NACK |
| Base-Station | BS |
| Code Block | CB |
| Code Rate | CR |
| Channel Quality Indicator | CQI |
| Forward Error Correction | FEC |
| Hybrid Automatic Repeat Request | HARQ |
| Incremental redundancy | IR |
| Two-Dimensional Hybrid Automatic | 2D HARQ |
| Repeat Request | |
| Low Density Parity Check | LDPC |
| Long-Term Evolution | LTE |
| New Radio | NR |
| Retransmission | ReTx |
| Transmission | Tx |
| Transport Block | TB |
| User Equipment | UE |
| Vertical Code Block | VCB |
| Code Block Group | CBG |
| HARQ process number | HPN |
| Downlink control information | DCI |
| Physical downlink shared channel | PDSCH |
| New Data Indicator | NDI |
| Physical uplink control channel | PUCCH |
| Scheduling request | SR |
| Logical Channel | LC |
| Multiple Access | MA |
| Quality of Service | QoS |
| ultra-reliable low latency | URLLC |
| communications | |
| Enhanced mobile broadband | eMBB |
| massive Machine Type | mMTC |
| Communications | |
| Modulation Coding Scheme | MCS |
| Physical uplink shared channel | PUSCH |
| Multiple input multiple output | MIMO |
| Downlink control information | DCI |
| Uplink control information | UCI |
| Group-common PDCCH | GC-PDCCH |
| Grant free | GF |
| Configured grant | CG |
| Uplink shared channel | UL-SCH |
| Medium Access Control | MAC |
| Medium Access Control- Control | MAC-CE |
| Element | |
| Code block group | CBG |
| Resource Block | RB |
| Resource Elements | RE |
| Transport block size | TBS |
| Cyclic redundancy check | CRC |
| Block error rate | BLER |

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

Features disclosed herein in the context of method embodiments, for example, may also or instead be implemented in apparatus or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

What is claimed is:

1. A method comprising:
encoding a plurality of code blocks to generate a plurality of codewords, the plurality of codewords comprising a first codeword and a second codeword; and
outputting the first codeword and the second codeword;
wherein the first codeword generated by encoding a first code block of a first code block group that is associated with a first traffic type, the first code block comprising information bits from only the first traffic type,
wherein the second codeword is generated by encoding a second code block of a second code block group that is associated with a second traffic type different from the first traffic type, the second code block comprising information bits from the second traffic type and bits associated with the first code block, and
wherein the first codeword is decodable independently of the second codeword, and further decodable jointly with the second codeword.

2. The method of claim 1, wherein a first size of the first code block is limited by a first maximum code block size and a second size of the second code block is limited by a second maximum code block size different from the first maximum code block size.

3. The method of claim 1, further comprising:
transmitting, in response to a decoding failure for one of the first code block group or the second code block group, a retransmission for the one of the first code block group or the second code block group.

4. The method of claim 1, wherein:
the second code block group comprises a plurality of second code blocks, and
the encoding comprises encoding the plurality of second code blocks to generate a plurality of second codewords.

5. The method of claim 1, wherein:
the first code block group comprises a plurality of first code blocks,
the encoding comprises encoding the plurality of first code blocks to generate a plurality of first codewords, and
the second code block comprises bits associated with the plurality of first code blocks, the plurality of first codewords being decodable independently of the second codeword, and further being decodable jointly with the second codeword.

6. The method of claim 1, wherein the bits associated with the first code block are positioned in the second code block based on reliabilities of bit positions in the second code block.

7. The method of claim 1, further comprising:
transmitting the first codeword and the second codeword using respective communication resources that are mapped based on the first traffic type and the second traffic type.

8. The method of claim 1, wherein the second code block group comprises a subsequent code block group that is associated with the second traffic type, the subsequent code block group is subsequent to a preceding code block group associated with the second traffic type, and the subsequent code block group is subsequent to pre-emption of the second type of traffic by the first type of traffic from which the first code block comprises information bits.

9. An apparatus comprising:
at least one processor; and
a memory coupled to the at least one processor, the memory including instructions that, when executed by the at least one processor, cause the apparatus to:
encode a plurality of code blocks to generate a plurality of codewords, the plurality of codewords comprising a first codeword and a second codeword; and
output the first codeword and the second codeword;
wherein first codeword is generated by encoding a first code block of a first code block group that is associated with a first traffic type, the first code block comprising information bits from only the first traffic type,
wherein the second codeword is generated by encoding a second code block of a second code block group that is associated with a second traffic type different from the first traffic type, the second code block comprising information bits from the second traffic type and bits associated with the first code block, and
wherein the first codeword being decodable independently of the second codeword, and further being decodable jointly with the second codeword.

10. The apparatus of claim 9, wherein a first size of the first code block is limited by a first maximum code block size and a second size of the second code block is limited by a second maximum code block size different from the first maximum code block size.

11. The apparatus of claim 9, wherein the instructions, when executed by the at least one processor, further cause the apparatus to:
transmit, in response to a decoding failure for one of the first code block group or the second code block group, a retransmission for the one of the first code block group or the second code block group.

12. The apparatus of claim 9, wherein:
the second code block group comprises a plurality of second code blocks, and
the encoding comprises encoding the plurality of second code blocks to generate a plurality of second codewords.

13. The apparatus of claim 9, wherein:
the first code block group comprises a plurality of first code blocks,
the encoding comprises encoding the plurality of first code blocks to generate a plurality of first codewords, and
the second code block comprises bits associated with the plurality of first code blocks, the plurality of first codewords being decodable independently of the second codeword, and further being decodable jointly with the second codeword.

14. The apparatus of claim 9, wherein the bits associated with the first code block are positioned in the second code block based on reliabilities of bit positions in the second code block.

15. The apparatus of claim 9, wherein the instructions, when executed by the at least one processor, further cause the apparatus to:
transmit the first codeword and the second codeword using respective communication resources that are mapped based on the first traffic type and the second traffic type.

16. The apparatus of claim 9, wherein the second code block group comprises a subsequent code block group that is associated with the second traffic type, the subsequent code block group is subsequent to a preceding code block group associated with the second traffic type, and the subsequent code block group is subsequent to pre-emption of the second type of traffic by the first type of traffic from which the first code block comprises information bits.

17. A method comprising:
receiving a plurality of codewords generated by encoding a plurality of code blocks, the plurality of codewords comprising a first codeword and a second codeword; and
decoding the first codeword and the second codeword, the first codeword being decodable independently of the second codeword, and further being decodable jointly with the second codeword;
wherein the first codeword is generated by encoding a first code block of a first code block group that is associated with a first traffic type, the first code block comprising information bits from only the first traffic type, and
wherein the second codeword is generated by encoding a second code block of a second code block group that is associated with a second traffic type different from the first traffic type, the second code block comprising information bits from the second traffic type and bits associated with the first code block.

18. The method of claim 17, wherein a first size of the first code block is limited by a first maximum code block size and a second size of the second code block is limited by a second maximum code block size different from the first maximum code block size.

19. The method of claim 17, further comprising:
receiving, in response to a decoding failure for one of the first code block group or the second code block group, a retransmission for the one of the first code block group or the second code block group.

20. The method of claim 17, wherein
the second code block group comprises a plurality of second code blocks, and
the receiving comprises receiving a plurality of second codewords generated by encoding the plurality of second code blocks.
